(19) United States
(12) Patent Application Publication
(10) Pub. No.: US 2009/0021513 A1
(43) Pub. Date: Jan. 22, 2009

(54) Method of Customizing 3D Computer-Generated Scenes

(75) Inventors: Vikram Joshi, Los Gatos, CA (US); David Tin Nyo, San Francisco, CA (US); Poojan Kumar, Mountain View, CA (US)

Correspondence Address: Stevens Law Group, 1754 Technology Drive, Suite #226, San Jose, CA, 95110, US

(73) Assignee: PixBlitz Studios Inc., Cupertino, CA (US)

(21) Appl. No.: 12/113,664

(22) Filed: May 1, 2008

Related U.S. Application Data
(60) Provisional application No. 61/038,946, filed on Mar. 24, 2008.
(60) Provisional application No. 60/961,006, filed on Jul. 18, 2007.

(51) Int. Cl. G06T 15/00

(52) U.S. Cl. 345/419

(57) ABSTRACT

An automated method of rapidly producing customized 3D graphics images in which various user images and video are merged into 3D computer graphics scenes, producing hybrid images that appear to have been created by a computationally intensive 3D rendering process, but which in fact have been created by a much less computationally intensive series of 2D image operations. To do this, a 3D graphics computer model is rendered into a 3D graphics image using a customized renderer designed to automatically report on some of the renderer's intermediate rendering operations, and store this intermediate data in the form of metafilm. User images and video may then be automatically combined with the metafilm, producing a 3D rendered quality final image with orders of magnitude fewer computing operations. The process can be used to inexpensively introduce user content into sophisticated images and videos suitable for many internet, advertising, cell phone, and other applications.

This application claims the priority benefit of provisional patent application 61/038,946 “Method of Customizing 3D Computer-Generated Scenes”, filed Mar. 24, 2008. The contents of this application are included herein by reference.

### BACKGROUND

High quality Three Dimensional Computer Generated Imagery (3D-CGI) of real imaginary scenes and landscapes is now ubiquitous. On video games, television, and movies, as well as many different forms of graphic images in print media and web pages, everyone has become quite accustomed to such images, and even realistic images and movies of quite impossible scenes have become so commonplace as to not attract much notice.

Typically 3D-CGI is constructed by a process in which a 3D graphics artist (or a computer program) first creates a computer model of a scene, often by creating multiple different figures or “objects” in wireframe form with multiple vertices and surfaces. The 3D graphics artist will in turn specify the properties of the various surfaces in the model, typically by attaching labels to the surfaces that describe the surface's color, texture, specular properties (how shiny), transparency, and other properties. The 3D artist also specifies other elements of the image, such as bitmap textures for the surfaces (which add a digital image, such as an image of bricks, to a surface such as a wall where the artist wishes such an image), bump-mapping (which can add a bumpy 3-dimensional texture to designated surfaces), and procedural textures (which can add synthetic fractal images, noise, and turbulence appearance to the surface to add realism). These artist-defined surface properties are collectively known as the “material” for the surface. After the 3D graphics computer model is created, and the artist has placed lights and a camera in the scene, the wireframe model is turned into a high quality 2D representation of the 3D image by another computerized process called rendering.

Typically, a technique called scanline rendering determines the visible surfaces in the scene by considering how surfaces will be ordered in depth at each pixel of each line in the output image. The material (as specified by the artist) on the front most surface is retrieved and various techniques are employed to determine the behavior of lighting and shadows on this material. A technique called ray-tracing can be used to accurately model the way light reflects and refracts through surfaces. This technique requires additional lookups of surfaces and materials as the light rays are bounced around the 3D scene, which can be very time- and memory-intensive. Another more advanced technique called radiosity attempts to physically model the global energy properties of light as it radiates through the scene. The algorithms to solve these physical simulations are even more intensive than ray-tracing.

Due to the large amount of processing power needed, high quality (motion picture grade) rendering is often done using large numbers of sophisticated computers networked together to form “rendering farms”, and these rendering farms slowly and expensively grind out high quality rendered images on a non-real time basis. Increases in speed are only obtained by adding more machines to the network, requiring significant expenditures for new hardware and additional software licenses.

Rendering programs are often written in computer languages such as C and C++, and often run on popular operating systems such as Linux, Unix, Microsoft Windows, and OSX. Rendering programs usually are composed of thousands of lines of highly complex code. Although this code can be written in many alternate ways, at a fundamental level, different rendering programs all do very similar things. That is, rendering programs all apply known principles of physics and optics, along with a few shortcuts, to deliver realistic looking images of imaginary scenes. To produce images that look good enough to be satisfying to human viewers, the underlying physics and optics must be reasonably accurate. As a result, the rendering process can be more easily understood by understanding the underlying physics, optics, and other motivations (i.e. various shortcuts) behind the complex computer code.

Renderers often use a scene description language to implement their various functions, and two popular high-end scene description languages are Mental Ray scene description language (Mental Images Corporation, Berlin Germany), and the Renderman shading language (Pixar Corporation, California). This scene description language helps the human programmer understand what the renderer is doing at a higher physics and optics level, while also giving the computer renderer specific instructions on how to implement the rendering process.

For example, the Renderman shading language (RSL), described in “The RenderMan Interface”, Version 3.2.1, Pixar Corporation, November 2005, pages 109-111, submitted as an IDS, shows how various renderer functions or steps may interact in a sequential order to produce a final high quality image. As this reference teaches:

“Conceptually, it is easiest to envision the shading process using ray tracing . . . In the classic recursive ray tracer, rays are cast from the eye through a point on the image plane. Each ray intersects a surface which causes new rays to be spawned and traced recursively. These rays are typically directed towards the light sources and in the directions of maximum reflection and transmittance. Whenever a ray travels through space, its color and intensity is modulated by the volume shader attached to that region of space. If that region is inside a solid object, the volume shader is the one associated with the interior of that solid; otherwise, the exterior shader of the spawning primitive is used. Whenever an incident ray intersects a surface, the surface shader attached to that geometric primitive is invoked to control the spawning of new rays and to determine the color and intensity of the incoming or incident ray from the color and intensity of the outgoing rays and the material properties of the surface. Finally, whenever a ray is cast to a light source, the light source shader associated with that light source is evaluated to determine the color and intensity of the light emitted. (p 109-110, and figure 9.2).

High end renderers and shading languages allow these various intermediate steps to be turned on and off by the user, and to be run either individually, or in various combinations as desired.

Often, the bitmaps and textures that the artist wishes to map onto a wireframe surface are flat, but the wireframe surface itself is often not flat, and in fact may be quite warped. In order to have this mapped surface look and act realistically in various lighting situations, the bitmaps or textures are mapped from their original coordinates into the wireframe surface u, v coordinates. To make this process smoother and more realistic (i.e. a wireframe surface has an inherently faceted nature, while most real surfaces do not), the rates of change of the wireframe surface coordinates du, dv are also computed, and thus the mapping of intermediate points can be calculated by linear interpolation between the nearest u, v, coordinate using the du and dv data. This creates a smooth mapping that is realistic enough for most commercial rendering purposes. (See ibid, pages 119-120 and FIG. 12.1).

Although such 3D-CGI is now commonplace, not all 3D images are equally compelling. Scenes that are computationally complex to create and render tend to look more impressive and realistic, and scenes created on limited budgets, or rendered by computer rendering systems with less computing power, generally tend to look less impressive and realistic. Typically a less costly 3D model will have either fewer graphics elements, repeated graphics elements, or less detailed graphics elements. A 3D model rendered on less costly and sophisticated computer rendering systems (such as a child's video game system) will also tend to look less realistic because in order to reduce the complexity of the rendering process, various rendering steps will be oversimplified or skipped. Surface textures may be rendered less precisely, reflection and refraction effects may be ignored, and many other optical-physics type calculations either simplified or omitted.

Because 3D graphics images are so ubiquitous, however, the average person, having seen thousands of such images in various contexts, has become remarkably sophisticated at judging, at least on a subconscious level, if a particular 3D image has been produced on high-end equipment, such as the equipment used to produce the 3D images in recent successful Hollywood movies, or on low end equipment, such as a child's video game. Depending upon the viewer's subconscious perception of the labor and sophistication used to create a particular 3D image or scene, a viewer may be either impressed at the level of effort used to create an image, or alternatively be unimpressed if the scene appears to have been created using inexpensive equipment and production values.

This subconscious perception of 3D image “quality” has many business consequences. In many areas of life, including commerce, the worth of an item or a product is often judged by the amount of effort that went into packaging or promoting the item or product. This judgment, often referred to by anthropologists as “costly signaling”, is based on an unspoken belief that more effort is spent on promoting and packaging valuable products, while less effort is spent on less valuable product. This is one of the reasons why advertisers may spend hundreds of thousands or millions of dollars on sophisticated graphics to promote their products—the advertisers are sending a “costly signal” to the audience that their products are valuable.

Compelling 3D graphics are also useful for many other areas. Through millions of years of evolution, the human mind has become extremely adept at rapidly processing visual information, and compelling 3D graphics allow new data to be quickly absorbed and understood with minimal amounts of effort. Compelling 3D graphics have many other excellent artistic and attention getting qualities, as well.

As computer technology advances, the increase in available computational ability to produce more sophisticated 3D images is balanced by increased viewer expectations. Thus while the subjective impression of “high quality” 3D graphics and rendering constantly changes with time as computer technology improves, one thing that does remain constant is that the perception of “high quality” 3D graphics will always tend to favor the more expensive 3D graphics produced by more detailed 3D models and more computationally intensive rendering processes. For example, the realistic effects produced by ray tracing are a form of costly signaling because ray tracing is very computationally expensive, and these effects are often omitted by cheaper systems.

Although everyone, including amateur and professional artists, web designers, and movie producers prefer high quality but low cost 3D graphics, advertisers, and other producers of promotional materials have a particularly strong financial motivation in this area. This is because advertisers wish to take advantage of “costly signals” to convince customers that their products have high worth, yet at the same time, due to advertising budget constraints, ironically wish to send “low cost” “costly signals”. That is, many advertisers would ideally like to use impressive and expensive looking 3D graphics to promote their products, yet not actually spend the money to produce such impressive looking 3D graphics. Thus methods to inexpensively produce 3D graphics images that appear to have been produced by a sophisticated and “costly” 3D production and rendering process are of high commercial interest.

One way to reduce the cost of producing promotional materials with sophisticated 3D graphics is to merge an image of a product onto high quality “stock” 3D rendered images. For example, a video may show an image of a high quality 3D rendered movie, and then superimpose an image, logo, or title over a movie. Alternatively, the new image may be manipulated, and then superimposed over stock 3D rendered images. However audiences are also used to such simple compositing schemes, and as a result, such simple ways to reuse expensive 3D graphics are not very compelling.

One fairly common method to merge new images into pre-existing image or film information is the technique of digital compositing. Here, an input pixel from the new image is merged with an input pixel from the pre-existing image. This merging process, called “alpha blending” is often controlled by an opacity value variable a, that determines the relative weight that the input pixel and the pre-existing image pixel are to be given in the final pixel. Such digital compositing can also take the relative positions of the new image and the pre-existing image (i.e. foreground or background) into account. Other compositing operations can include new-image scaling, color-correction, and retouching.

A number of commercially available digital compositing systems exist, including the programs “Shake” produced by Apple Corporation, “Combustion” produced by Autodesk Corporation, “After Effects” produced by Adobe Corporation, and “Fusion” produced by Eyeon Corporation. These programs are often used in by expensive production houses to insert complex images into high-budget motion pictures as part of various post-production special effects.

Digital compositing systems tend to be either node-based or layer based. If node based, the systems produce the composite image as a tree consisting of various objects and procedures, which allows great flexibility, but handles animation with less realism. By contrast, layer based compositing systems, such as Adobe “After Effects”; give each object its own layer and its own timeline. This allows for superior animation, because each object has its own clear timeline, and the different layers, which are all synchronized in time, can thus be merged in a straightforward manner.

One limitation of prior-art digital compositing systems such as Adobe “After Effects”, however, is that at a basic level, these programs are fundamentally manually controlled. That is even though, as described in the “Adobe Aftereffects CS3 professional Scripting Guide ”, Adobe Systems Inc. 2007 (submitted in the IDS), these systems often have a scripting capability, the scripting capability continues to be manually oriented in that it assumes that a human operator will write the scripts, based upon the human operator's artistic insights and computer programming capability, to achieve the desired artistic effect.

Thus in spite of all the automated elements, the human operator still must visually assesses how realistically the various digital compositing processes merge a new image with a composited image, and based upon the operator's judgment, iteratively adjust the compositing process or script until the merged images look visually pleasing. This is a very slow process and requires a skilled operator.

As a result, due to their fundamental reliance on human operator judgment and control/script manipulation, prior art digital compositing systems were themselves quite high budget in terms of operator cost and time. Although useful for inserting special effects into high budget motion pictures, the fundamentally manual methods of prior art digital compositing systems were unsuited for the low cost, rapid customization objectives of the invention.

### BRIEF DESCRIPTION OF THE INVENTION

The present invention discloses an automated method of rapidly producing customized 3D graphics images that appear to have been created by a costly 3D graphics production and rendering process, but which in fact have been automatically created by a much lower cost process optimized to render only the changed parts of the 3D scene, and the effect of the changed parts on the rest of the scene. For example, a changed material or texture may need to get reflected or refracted, possibly recursively, and affecting the ambient occlusion of the scenes and hence the image. Here a master 3D graphics model is produced one-time by an “expensive” 3D graphics model and a special diagnostic rendering process. This expensive master 3D graphics scene can then be rapidly and automatically blended or merger or 3D composited with any number of custom 3D scenes, objects, graphic images, and movies by an optimized rendering process in a way that preserves important rendering details, resulting in a final 3D image that looks as if it had been processed from the beginning by a computationally intensive rendering process.

The invention allows the high cost of an original 3D graphics model and diagnostic rendering process to be amortized by the many different customized variants, producing many different high quality but customized 3D images and movies that can be used for a variety of different purposes and users.

### BRIEF DESCRIPTION OF THE FIGURES

FIG. 1 shows a sample 3D graphics model with refracting and reflecting elements, a tagged region of this model, and several user images that may be potentially put into the tagged region of the model.

FIG. 2 shows an example of a 3D rendering program that has been customized through the use of various diagnostic or reporting materials, plugins, and scripts to output certain intermediate rendering steps in the form of metafilm files.

FIG. 3 shows an example of a simple diagnostic or reporting material, used to output information pertaining to intermediate steps in the rendering process.

FIG. 4 shows an example of a simple diagnostic or reporting material and a simple light controlling script, used to output information pertaining to intermediate steps in the rendering process.

FIG. 5 shows an overview of how a 3D graphics model is converted to metafilm by using the diagnostic materials in combination with the original 3D rendering program, and how the metafilm and user images may then be processed by a metafilm based reconstruction engine to produce a 3D image containing the user image that looks as if it was rendered by the 3D rendering program, but in fact has been produced by a much less computationally intensive process.

FIG. 6 shows a detail of some of the various metafilm layers, and how they work.

FIG. 7 shows an overview of how the metafilm reconstruction engine takes various metafilm layers, and user input images, and combines the two to produce a 3D image containing the user image that looks as if it was rendered by a computationally intensive 3D rendering program, but in fact has been produced by a much less computationally demanding process.

FIG. 8 shows an example of a first internet server having a metafilm library and metafilm based reconstruction engine, interacting with a second internet image or video server, and sending customized 3D graphics containing embedded user images to user devices.

### DETAILED DESCRIPTION OF THE INVENTION

To better understand the nature of the problem, consider what happens in a situation where a 3D graphics model is rendered and viewed from a moving point of view, such as in a video. When 3D graphics scenes move, the angles of lighting continually change, various 3D objects are blocked and unblocked by other 3D objects, images from one 3D graphics object, such as a shiny or transparent object, may be refracted or reflected by other 3D graphics objects. Now imagine the problems of simply trying to drop in a new image or video into the rendered scene by a standard digital compositing process, such as alpha blending. Unless the new image or video is processed to look entirely natural in its new context, with variable angles, lighting, surface shapes, surface textures, reflection, refraction etc., the new image or video will look unnatural. Instead of appearing as a real element of the 3D “world”, the new image or video will appear as if it has simply been pasted on to the scene, which of course it has been. This will look unnatural and “cheap“and destroy the artistic integrity of the 3D graphics model.

In order for the customization process to be done in an automated manner that preserves the high quality rendering process of the original master 3D graphics scene, the new images or video (customized elements) must be automatically merged with the master 3D scene in a way that is consistent with the rest of the scene. However, short of detailed manual human inspection and artistic manipulation of parameters on an iterative basis, this information to do this cannot be automatically obtained from the final rendered master 3D graphics image. This is because the final rendered master 3D graphics scene is typically composed of such a large and convoluted mix of lighting from different sources, textures, and other elements as to make determination of each individual 3D graphics rendering process essentially unsolvable.

The information to do this merge process also cannot be obtained from the initial 3D graphics model prior to rendering, because this 3D graphics model (which typically consists of a series of points, verticies, connected lines, textures, and the like) lacks the essential 3D rendering information needed to make a realistic image. Indeed, the same 3D graphics model can be run on different renderers and different render settings to create a wide variety of different 3D images. Where then, will the missing information, needed to automatically and realistically merge the new images or video, be obtained?

As previously mentioned, the process of rendering proceeds as a series of steps, where each step can often be understood in terms of a simple physics or optical processing step. Each step creates a large amount of intermediate data, here called “diagnostic data” or “metadata”. This metadata can be thought of as an intermediate scaffold or tool that is used to create the final displayed image. Just as a scaffold is usually discarded when a building is constructed, so the metadata is usually discarded when the final image (the commercially useful output from the rendering process), is completed. Just as a scaffold is not artistically pleasing or useful, so metadata is usually regarded as not being very artistically pleasing or very useful either.

The exact methods and software used in many commercially important renderers are often guarded as trade secrets. Thus many commercially important but “closed source” renderers (which at the time of this writing include popular renderers such as Autodesk Maya and 3D studio max) are not configured to release much of this intermediate diagnostic data or metadata. The final output of such “closed source” renderers are of course made available, but many aspects of the precise inner workings and intermediate data of such renderers are often treated as proprietary “black boxes”. Often, only enough aspects of the “black box” are revealed in order to allow customers to get adequate final images and video.

Even present “open source” renderers are not really configured to adequately record and store metadata. Why bother, since until now, metadata was largely regarded as a semi-worthless byproduct of the rendering process? Thus for both open and closed source renderers, positive steps must be taken to obtain and save metadata suitable for the present invention. Here, these positive steps are often referred to as reporting rendering passes, the output from these reporting rendering passes are often referred to as diagnostic information files or metadata files, and renderers modified to report useful metadata are referred to as diagnostic 3D renderers.

Thus one important aspect of the invention is the concept of modifying either closed source or open source 3D graphics software to create diagnostic versions of the materials, and then running these diagnostic or reporter materials with the intent of systematically harvesting the large amounts of metadata generated during the rendering process. The invention further teaches how this metadata can then subsequently be used to automatically control a highly efficient and specific rendering process that automatically merges arbitrary user images or video with the metadata, allowing the new images to be precisely transformed to match the transformation processes that took place in the original renderer. The end result is an inexpensive and rapid process to realistically embed user images and video into compelling 3D worlds, which can be used for a variety of different applications.

Thus in a first aspect of the invention, certain types of diagnostic information or metadata generated during a diagnostic 3D rendering of a master 3D graphics image is obtained and saved in the form of various diagnostic information files. Both open and closed source rendering software usually provide an API (application programming interface) for generating or modifying materials and objects in a 3D scene. This API is used to create custom materials and objects that provide diagnostic and reporter information when the original renderer is invoked.

In a second aspect of the invention, the metadata obtained from the original diagnostic run of the 3D model renderer, which preserves important aspects of the rendering calculations used in the original 3D renderer, is automatically used to transform the new images or video, causing the new image to be rendered as if it had been rendered by the original 3D renderer. The transformed new images are then merged with a 3D background image specially created for this process, creating the final image. All this can be done automatically, without human intervention using scripting languages which are built into the original 3D rendering software.

In order to allow this process to proceed on an automatic basis, the stock 3D graphics model must first be created, and the portions of the model where new user graphics or video can be incorporated must be marked. To do this, 3D graphics model is constructed using a 3D computerized graphics editor using standard methods, and the operator places a machine readable tag, marker, or label on those portions of the 3D model where new user graphics or video is allowed. As an example, if the 3D model is of the inside of an art gallery, the artist might tag the interiors of the various paintings as being replaceable with user images. As a more complex example, the face of a dummy sitting in the driver's seat in a 3D model of a car might be tagged as being replaceable with user images or video, so that a user could subsequently visualize how he or she might look while driving the car.

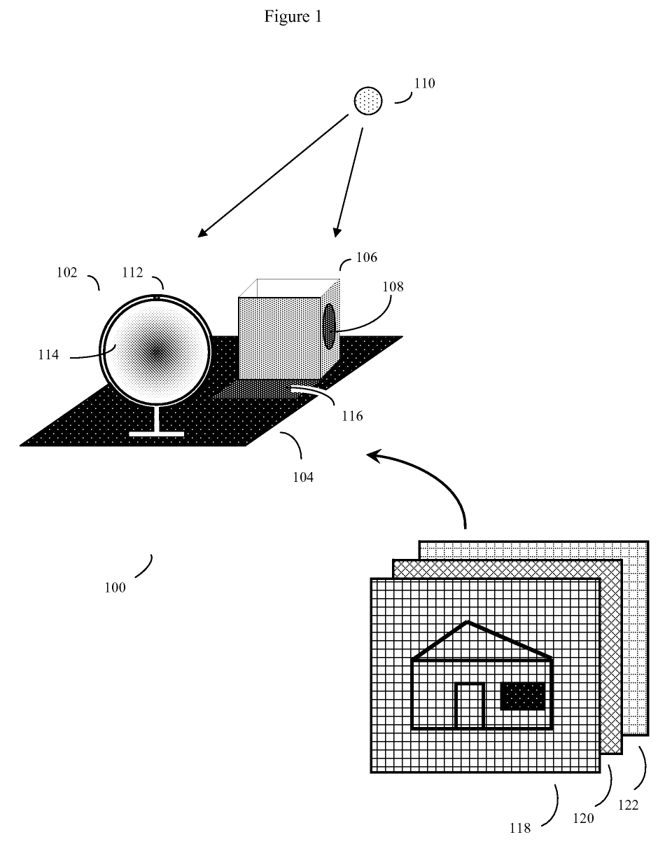

FIG. 1 shows an example of such a stock 3D graphics model. This example shows a simple 3D graphics scene (100) with a magnifying glass (102) sitting on a surface (104). On the surface is a hollow box (106) with a hole (108). Inside the box (not shown) is a light bulb. Scene (100) is illuminated from behind by a directional light source (110), and also from all sides by omni-directional light (not shown). Magnifying glass (102) has a shiny metal rim and support (112), and the interior of the magnifying glass is filled with a transparent lens with refracting properties (114). Due to directional light source (110), box (106) casts a shadow (116) on surface (104).

In this example, the artist has indicated that the surface (104) can be replaced with any arbitrary user image, video or texture (118) (For example the arbitrary image could be a picture of a house, as shown on the top of the stack of potential user images, or any other photograph, movie, or textured surface). In this way, the stock 3D scene 100 can be reused many times with different images (118).

Note however that realistically, rapidly, and cheaply merging many user images (118) with this stock 3D graphics model (100) isn't going to be an easy task. In fact prior art digital compositing methods would find this to be a very labor intensive, slow, and expensive manual process; and the final results might not be very satisfactory because human judgment would be required, and the results might not be very accurate. In this example, the magnifying glass (102) is reflecting the new image (104) in its shiny rim (112), along with non-changing portions of the 3D graphics mode. The magnifying glass is also magnifying new image (104) with the refracting properties of the lens (114). Additionally, the shadow cast by light source (110) and box (106) is creating a shadow on new image surface (104). The internal lamp inside box (106) shining through hole (108), and thus may create a glow on surface (104).

Probably the most satisfactory prior art solution to this problem would be to first put the new image or video (118) onto surface (104) in the 3D graphics model, and then pass the scene through the 3D graphics renderer again. However, since high quality rendering can be very computationally intensive, this could, at a high enough quality setting, require hours or days on an expensive computer or render farm, and thus be expensive and commercially unattractive when a large number of different user images (such as a user video) was desired to be put onto surface (104).

Using the techniques of the invention, however, this expensive re-rendering does not have to be repeated each time a new image (118) is put onto surface (104). Rather, as previously discussed, the slow and computationally expensive rendering process need be done only once, and the intermediate calculation metadata, normally discarded at the completion of the rendering process, instead may be saved and used to realistically incorporate arbitrary new images (118) onto surface (104) with orders of magnitude less computing overhead than was required for the original rendering process.

To do this, the 3D graphics model constructed in FIG. 1 is processed by a diagnostic 3D graphics renderer. However instead of producing a normal rendered 3D graphics image of the scene, the 3D graphics model is instead rendered by a number of different rendering passes designed to extract useful diagnostic metadata from the rendering process.

As previously discussed, although 3D rendering itself is a complex process, the underlying concepts behind 3D rendering are generally closely based on standard physics and optical principles. Thus the software that implements these standard physics and optical rendering steps can best be understood by describing the underlying physical or optical intent of the software. Once the intent of a particular software step is understood, the software itself may be written in many alternative languages and forms yet perform the same purpose. Thus, for simplicity and ease of communication, this disclosure will favor the method of describing the various underlying software modules in terms of their basic functionality.

In order that the basic logic of the reporting or metadata extraction process be more easily understood, as well as to illustrate how these concepts may also be implemented with many “closed source” renderers, the underlying techniques by which the valuable intermediate data (metadata) may be discovered and output will be explained in terms of the underlying physics and optics of the various rendering steps and rendering passes. These methods are also useful because they work well with closed source renderers (through their “open” APIs).

With this technique, during certain “diagnostic” “or “reporting” rendering passes the diagnostic rendering pass subjects the stock 3D graphics model to certain conditions designed to isolate and report on specific aspects of the rendering process. Typically each “reporting” rendering pass is a pass in which the properties of the labeled areas (areas where the artist desires that new images may be inserted into the 3D graphics model) of the 3D graphics model are distinguished from the properties of the unlabeled areas of the 3D graphics model (all the other parts of the 3D model that don't change when new images are added), and the labeled and unlabeled areas then rendered in special reporting rendering passes that often vary the lighting, material, or shading parameters used during the rendering process.

If a closed source renderer is used for diagnostic rendering, the output from the diagnostic rendering or reporting passes can then be processed by the “closed” renderer's graphics engine as usual, and converted into standard computer files, such as two dimensional files or movie files, that contain the metadata expressed in an image-like format. Note, however, that although the metadata files produced in this manner look “image like”, the colors of these metadata “image” files often represent non-color variables, such as image texture and surface coordinates, texture mapping indices, and the like.

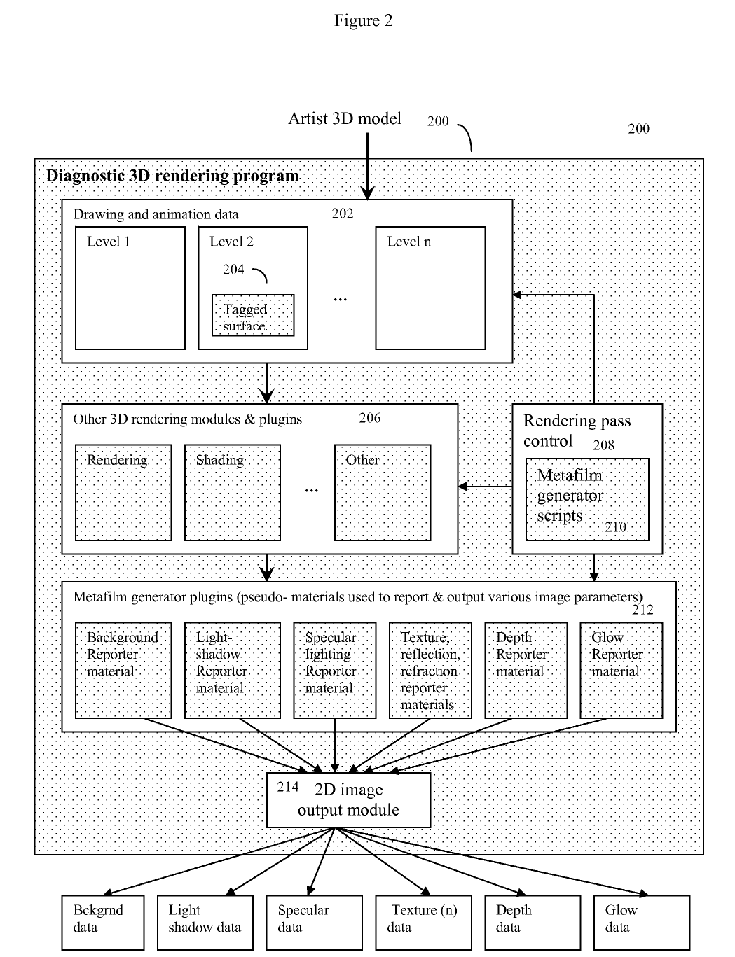

An example of the diagnostic or reporting rendering passes needed to create metadata useful for the present invention is shown in FIG. 2.

In this figure, the data from the 3D graphics model corresponding to the data used to construct FIG. 1 (100) is used as the input to a diagnostic 3D rendering software package (200). The 3D graphics model data (202) will typically be composed of various 3D graphics layers (i.e. one layer for the box, one layer for the background elements, one layer for the magnifying glass, etc.), as well as various 3D surfaces within each layer that the artist wishes to tag or mark as suitable for new images. In this example, the background surface (104) from FIG. 1 might be marked as the tagged surface (204) in level 2 of the input 3D model (202).

The diagnostic 3D rendering program (200) will contain standard 3D graphics rendering modules and plugins (206). Preferably the diagnostic 3D rendering program will also control its various parameters and rendering passes with a script control capability (208) which can accommodate metafilm generator script (210) capable of operating the 3D rendering program (200) in a customized manner.

In addition to the normal 3D rendering modules and plugins (206), the diagnostic 3D rendering program will additionally be equipped with a number of additional customized plugins and pseudo materials (212) that are used to run the diagnostic 3D rendering program in special diagnostic or reporting modes designed to elicit useful metadata about some of the intermediate steps in the rendering process. Some of these diagnostic or reporting plugins and materials include reporter materials for the background of the 3D graphics model, the light and shadow environment of the 3D graphics model, and the specular light environment, and refraction operations (often performed by localized ray tracing) during the rendering of the 3D graphics model.

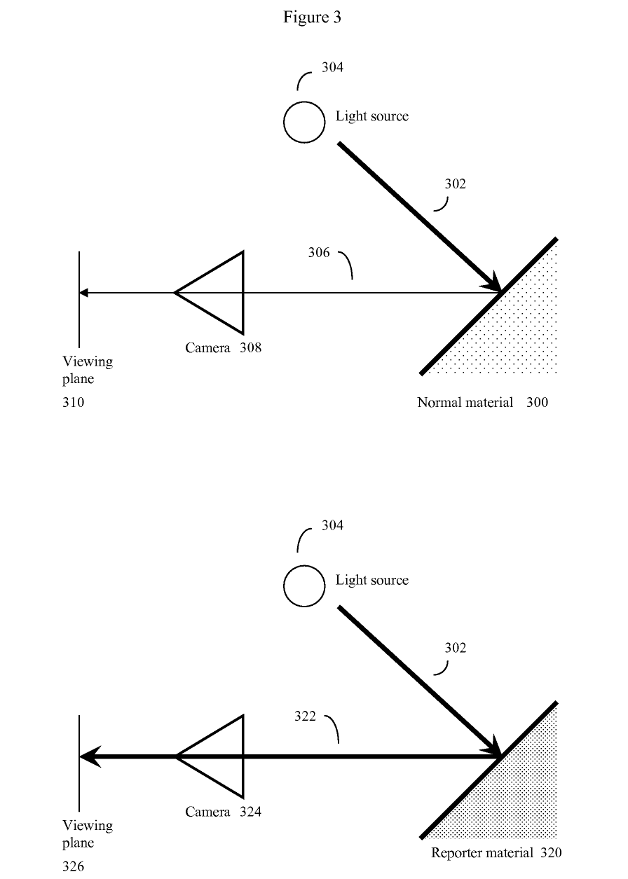

FIG. 3 shows an example of a special diagnostic material or texture that can be used as a reporter material to extract information that is useful for the present invention. A normal material or texture 300, when exposed to light (302) from light source (304) will reflect only a portion of the light (306) in a direction of a virtual camera (308) and viewing plane (310). This of course is required for a realistic image, but from a diagnostic rendering information standpoint, has the problem that light beam (306) is thus influenced by both light source (304), and material (300). This makes it difficult to determine exactly how much light is actually hitting surface (300).

For diagnostic rendering purposes, it is thus useful to vary (often under control of the metafilm generator scripts (210)), the properties of various materials in the 3D graphics scene. For example, suppose that the artist desired to replace the normal material or texture (300) with a new image with an arbitrary alternate image or texture and different reflection properties. In order to be sure that this arbitrary new image or texture was realistically portrayed, the amount of light impinging on this new image from light source (304) must be known.

In this example, assume that normal material (300) has been tagged by the artist as being a region of the 3D graphics image where new images may be placed. During the rendering process, the metafilm generator scripts (210) can examine various portions of the 3D graphics image for tagged regions, and replace these tagged regions with reporter materials (320). In this example, the reporter material (320) will be a 100% white material that reflects 100% of the light (302) from light source (304). As a result, the reflected light (322) as perceived by the renderer's virtual camera (324) and viewing plane (326) will give accurate information about the amount of light hitting surface (320), and this in turn can be used to adjust the illumination for any arbitrary new images that are put in this tagged region of the 3D graphics image.

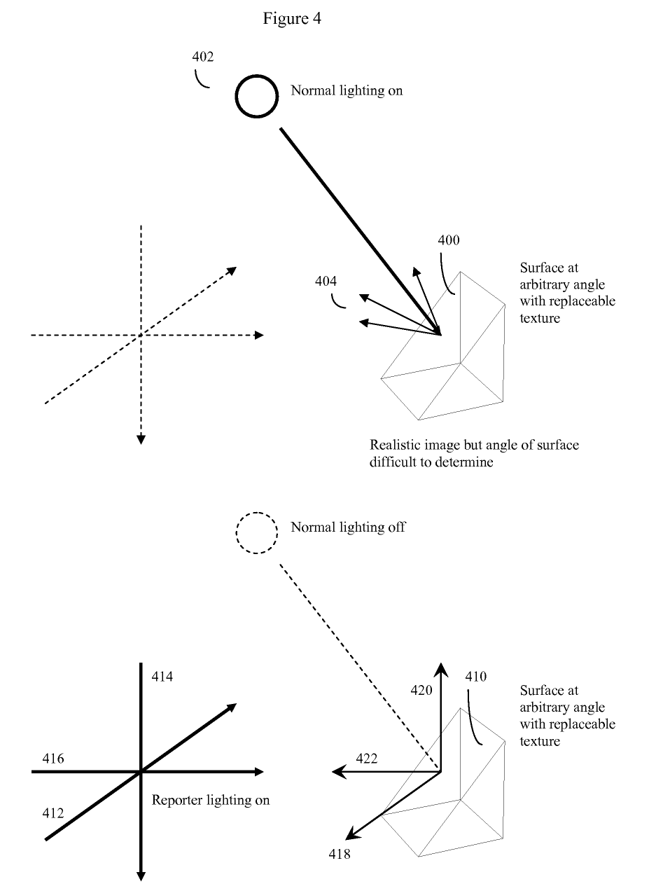

FIG. 4 shows another example of a special diagnostic material or texture that can be used as a reporter material to extract information that is useful for the present invention, as well as an example of a diagnostic script that can vary the operation of the diagnostic renderer to produce metadata. As an example, assume that the renderer is a closed source renderer that is reluctant to expose texture UV and du dv information. In this case, this information could be extracted despite the lack of cooperation, by use of special diagnostic lighting and renderer control scripts.

In this situation, the tagged surface (400) may be at an arbitrary angle in the 3D graphics model. In a normal situation, light from multiple light sources, including light source (402) may impact the surface from multiple arbitrary angles. Thus the surface (400) will emit a complex pattern of partial specular reflection, partial diffusive reflection, and of course its own color, so it is difficult to determine much about the angle and orientation of the surface just by examining reflected light (404).

In order to determine the exact angle and orientation of surface (400), the metafilm generator diagnostic scripts (210) would first replace the material in the tagged area with a special mirror-like 100% specular material (410). The metafilm generator scripts (210) could then turn off the normal light sources, such as light source (402), and instead turn on various types of diagnostic lighting, as shown in (412), (414), and (416). The scripts can turn on the lighting in sequential order, rather than all at once, and can also arrange the diagnostic lighting so that it can be along a defined axis such as the image x, y, and z axis. This diagnostic lighting in turn causes reflected lighting (418), (420), (422) from surface (410) to convey information pertaining to the angle of surface (410), and this in turn can be automatically processed to give information pertaining to the orientation of surface (400) and (410).

Many other types of reporter or diagnostic materials, textures, and scripts can be created for these purposes, and some other examples will be provided later in this discussion.

Standard 3D rendering programs are typically designed to output the results of the rendering process as a series of one or more graphics or video files, and contain built in software conversion routines designed for this purpose (214). Although, as previously discussed, the diagnostic or reporting data could, in principle, be output in many alternative different types of non-standard file formats, often it is both convenient and more efficient to utilize the standard 3D rendering graphics output software routines and file formats, and simply remap some of the data in these standard file formats into alternate variables and formats that are more appropriate for the diagnostic or reporting metadata of interest.

Thus, as previously discussed, while a standard 3D graphics renderer might output a graphics file in the PNG format with the red, green, and blue channels being used for standard red, green, and blue colors, for the purposes of outputting useful metadata, the “red” channel can be remapped to store an alternative variable, such as a “u” texture channel, the green channel can be remapped to store an alternative variable, such as the “v” texture channel, and so on.

Thus often it will be convenient to output metadata in the form of various standard file formats, such as those supported by closed source renderers. These closed source renderers are typically designed to output data in either an image or video file format. Examples of such conventional image file formats, which can be used to store metadata, include image formats such as jpeg, tiff, raw, png, gif, bmp, ppm, pgm, pbm, pnm, svg, postscript, pdf, swf, wmf, lossless file formats, lossy file formats, and vector file formats. Examples of such conventional video file formats, which also can be used to store metadata, include formats such as 3pg2, 3gp, 3gp2, 3gpp, 3 mm, 60d, aep, ajp, amv, asf, asx, avb, avi, avs, bik, bix, box, byu, camrec, cvc, d2v, dat, dce, dif, dir, divx, dmb, dpg, dv, dvr-ms, dxr, eye, fcp, flc, fli, flv, flx, gl, grasp, gvi, gvp, ifo, imovieproj, imovieproject, ivf, ivs, izz, izzy, lsf, lsx, m1v, m21, m2v, m4e, m4u, m4v, mjp, mkv, mod, moov, mov, movie, mp21, mp4, mpe, mpeg, mpg, mpv2, mqv, msh, mswmm, mvb, mvc, nsv, nvc, ogm, pds, piv, playlist, pro, prprog, prx, qt, qtch, qtz, rm, rmvp, rp, rts (realplayer), rts (quicktime realtime streaming format), sbk, scm, sfvidcap, smil, smv, spl, srt, ssm, str, svi, swf, swi, tda3mt, tivo, ts, vdo, veg, vf, vfw, vid, viewlet, viv, vivo, vob, vp6, vp7, vro, w32, wcp, wm, wmd, wmv, wmx, wvx, and yuv, lossy video files, lossless video files, and vector video files.

Typically as a larger variety of different reporter rendering passes are performed and stored as metadata files, the fidelity and realism of the final reconstructed image at the end of the process will improve. Thus although not all rendering passes need to be saved as metadata files, generally the more, the better.

Some specific examples of these “reporting” rendering passes are discussed below. In these examples, it is assumed that a closed source renderer has output these passes as a series of two dimensional still image or video files or “layers”, where each pixel in the two dimensional file may have at least 3 values (for example, a red value, a green value, and a blue value) associated with that particular pixel. Many alternative formats are possible, however.

### Background Image Group

Background diffuse layer: The background part, image, or layer of the scene is, to a very crude first approximation, an image of the basic 3D scene itself without the various new user images added. That is, the background is the part of the scene that is unchanging with regards to the new user image input. Sometimes the new image, if it really had originally been incorporated into the stock 3D graphics model, could have interacted with the rendering process in unexpected ways. As an example, a new image could have an impact on the refraction and reflection properties of the 3D model and the final resulting image when rendered. As a result, since the new user image could cause a change in the subsequent reflection and refraction rendering passes (layers), the background layer only shows the “diffuse” component of the background objects in the scene. This background layer is generated by removing the tagged or labeled “new image areas” from the 3D graphics model, and then rendering the 3D graphics model. Reflections and refractions of background objects that do not interact with the input are rendered here as well. Because this background layer contains a large amount of the basic 3D rendered graphics model, this background layer is one of the most frequently used layers.

### Background Specular Layer (Combined or Per Light):

Similar to the Background diffuse layer, except only the specular data is rendered. This allows user adjustment of lighting during the generation of the final merged images or video. This layer can be a single layer encoding the contribution of all lights or multiple layers, one for each light, which allows individual lighting control.

### Background Light/Shadow Layer (Combined or Per Light):

Similar to the Background diffuse layer, except only the specular data is rendered. This allows user adjustment of lighting during the generation of the final merged images or video. This layer can be a single layer encoding the contribution of all lights or multiple layers, one for each light, which allows individual lighting control.

It should be noted, by the way, that for this discussion, the (N) in these labels means that there is a set of N parts of this layer, i.e. there is one for every input material (N inputs).

Input(N) Specular layer (combined or per light): This layer can be used when the new images are desired to have a high specular component, such as new images placed on to a tagged shiny surface. This layer shows what effect any specular properties of the new image might have on the scene. To generate this layer, the non-tagged portions of the 3D graphics model are converted to black, and the tagged portions of the 3D graphics model are made mirror-like. The renderer is invoked with the “specular” option turned on, and the data from the specular pass is stored into this buffer. Thus, for example, if the new image is shiny, and reflects light onto neighboring objects in the 3D graphics model, the input specular layer will reflect this, and the information can be used to increase the lighting on those portions of the background layer where more light would be expected.

This layer is a good example of a semi-optional metadata layer. If the new image is likely to have little specular properties (i.e. has a mat and non-shiny appearance), then this layer might be omitted with little impact on the realism of the resulting image. However if the new image is likely to be shiny, then this layer will become more important because the viewer will subconsciously expect that if the new image portion of the scene looks shiny, then it should be reflecting light on neighboring objects.

For the following, each different new tagged area of the 3D graphics model corresponding to the target for a new user image or video (input area) will typically get its own set of metadata. The general pattern is one of: 1) new image transformation functions (often base transformation functions, and derivative transformation functions), 2) optional new image mask, and 3) new image lighting data. The function of the optional new image mask is to limit the area of the new image transformation and lighting to just the area of the new image itself.

Thus if there are three new input images in the 3D graphics model, there will be three texture coordinates diffuse layers (1, 2, and 3), three texture coordinate derivative—diffuse layers, three input mask—diffuse, and three input light/shadow—diffuse layers. There will typically also be three layers of each type from the image reflection group, and three layers of each type from the image refraction group. Note that if a particular scene does not have a significant amount of refraction or refraction, any one of these groups may be omitted in order to reduce file size and computational time.

### New Image Basic (Diffuse) Texture Group:

This group maps the basic texture and image of the new image onto the tagged are of the 3D graphics model, and handles basic clipping and diffuse lighting, but does not handle the more exotic reflection and refraction effects. This group is thus fairly fundamental, and is frequently used. For example, if the new image was of a non-shiny and non-transparent material, the new image information would be primarily located in this group.

Texture Coordinates—Input(N) Diffuse Layer: This layer encodes the texture coordinates (UV) for the new image input areas, and can be thought of as a way to warp and stretch the new image, which often will be in simple x, y, Cartesian coordinates, into the shape of the tagged region of the graphics model, which usually will have a different geometry. To produce this layer, the non-tagged portions of the 3D graphics model are converted to black, and a special UV material is applied to each new image input areas. In some embodiments, this layer can encode the texture's spatial “U” data as a Red color and texture's spatial “V” data as a Green color. In some embodiments, this layer can also encode the material type used for the texture as a third “m” coordinate using the blue color.

In contrast to the reflection and refraction layers, to be discussed shortly, which often must bring in textures from the other parts of the 3D graphics model to look realistic (for example, a reflecting pond designated for replacement by a new scene must bring in a textures from trees elsewhere in the 3D model to look realistic), for the diffuse layer, the “m” coordinates for non-new image data is often less important. This is because since this is the diffuse layer, this portion of the image will generally lack the reflection or refraction properties that might bring textures from other portions of the 3D graphics image into the tagged area occupied by the new image. Thus, in some cases, the “m” coordinate here can simply be a pointer to the new user graphics image, or even can be omitted.

In order to avoid the problem of the renderers' anti-aliasing altering the red and green color data, the render will typically be invoked with anti-aliasing turned off. Only the diffuse render pass is used for this layer.

Texture Coordinate Derivatives—Input(N) Diffuse Layer: This layer encodes the derivatives of the texture coordinates (dU, dV) for the new image input areas over the screen space of the rendered 3D graphics model. As before, each different tagged area of the 3D graphics model for new user images (input area) will typically have its own layer. Thus if there are three new input images in the 3D graphics model, there will be texture coordinate derivatives—diffuse layers (1, 2, and 3). As before, to produce this layer, the non-tagged portions of the 3D graphics model are converted to black. A special dU dV material is applied to all input areas which, in one embodiment, can encode dU data as a Red color and dV data as a Green color. The renderer is invoked with no anti-aliasing to avoid altering the Red and Green color data. Only the diffuse render pass is used for this layer.

Input (N) Mask—Diffuse: This layer is a mask of the coverage of a single new image input area on the output screen space of the rendered 3D graphics model. As before, each different new image (input area) will typically have its own mask layer. To produce this mask layer, the single input area under consideration is converted to white, and all other areas are converted to black. The renderer's lighting and shadow features are turned off. The renderer is invoked and the diffuse render pass data is stored. The mask layer is semi-optional. As an alternative, which may be used when changes in the lighting color are not needed, the non-light areas of the input light shadow layer below may be set to black or zero, and these non-light areas may be used to convey mask information.

Input (N) Light/Shadow (L)—Diffuse Layer: This layer encodes the light shadow effects for the new image input areas. Each different new image (input area) will typically have its own layer. To produce this layer, all areas except the particular tagged new image input area are converted to black, and the input area is converted to white. The renderer is invoked and the results are stored to this layer.

Thus the only “lit” area in this particular metadata layer will be the area where the new image is going to go. If the new image will be illuminated by bright light, the image will be light, if the new image will be partially bright and partially in shadow, this particular metadata layer will show this as well.

This layer contains important information pertaining to how to best illuminate various areas of the new image in order to have the new image match the overall illumination of the 3D graphics model. Thus, for example, if the position of the new image in the overall 3D graphics model is such that the left side of the new image would have been exposed to bright light, and the right side of the new image would have been in shadow, the input light/shadow—Diffuse layer (n) will convey this information. This can be a combined result from all lights or individual layers for each light (L).

### New Image Reflection Texture Group:

This group adds additional texture and image information that is needed to realistically add the reflecting properties of the new image into the overall 3D graphics model. Thus, for example, if the new image was an image of a shiny reflecting object, this group would be quite important as the textures of the new image would contain distorted images of the non-tagged areas of the 3D graphics scene. This group is a good example of high quality “costly signaling” effects, because it effectively duplicates expensive ray tracing effects which normally would be produced by computationally intensive rendering techniques.

Texture Coordinates—Input (N) Reflection Layer: This layer encodes the texture Coordinates (UV) for the reflected portions of the new images. As before, each different new image (input area) will typically have its own layer. To produce this layer, the background (non-new image) areas are converted to black, and a special UV material is applied to all new-image input areas. In some embodiments, this layer can encode the texture's spatial “U” data as a red color, and the textures spatial “V” data as a green color. In some embodiments, this layer can also encode the material type used for the texture as a third “m” coordinate using the blue color. For example, since reflection will often reflect elements from other portions of the 3D graphics image that are not the new image, the m coordinate will often contain the textures for these other non-new image portions of the 3D graphics image. Thus, using the previous example where the tagged area of the 3D graphics model represents a reflecting pool, the “m” buffer of this layer can contain the textures of the trees in the 3D graphics model that are reflected by this pool.

Only the raytraced reflection render pass is used for this layer, and as before, the renderer is invoked with no anti-aliasing to avoid altering the Red and Green color data.

Texture Coordinate Derivatives—Input (N) Reflection Layer: This layer encodes the reflection layer of the derivatives of the Texture Coordinates (UV) for the reflected portions of the new images. As before, each different new image (input area) will typically have its own layer. This layer acts as a mask of the coverage of a single new image input area on the screen space of the rendered 3D graphics model output. Each new image will typically have its own layer. To produce this layer, the labeled new image input area under consideration is converted to white, and all other areas in the 3D graphics model are converted to black. The lighting and shadows options of the renderer are turned off. The renderer is invoked, and a raytraced reflection render pass run is performed. The data from this raytraced reflection run is stored as this layer.

Input (N) Mask—Reflection layer: This layer is a mask of the coverage of a single new image input area on the output screen space of the rendered 3D graphics model. As before, each different new image (input area) will typically have its own mask layer. To produce this mask layer, the single input area under consideration is converted to white, and all other areas are converted to black. The renderer's lighting and shadow features are turned off. The renderer is invoked and the raytraced reflection render pass data is stored. The mask layer is semi-optional. As an alternative, which may be used when changes in the lighting color are not needed, the non-light areas of the input light shadow layer below may be set to black or zero, and these non-light areas may be used to convey mask information.

Input (N) Light/Shadow (L)—Reflection layer: This layer encodes the light shadow effects for the new image input areas. Each different new image (input area) will typically have its own layer. To produce this layer, all areas except the particular tagged new image input area are converted to black, and the input area is converted to white. The renderer is invoked and the reflection render pass results are stored to this layer. This can be a single layer per input (N) with combined lighting, or one layer per input (N), per light (L) for separate lighting effects

### New Image Refraction Texture Group:

This group adds additional texture and image information that is needed to realistically add the refracting properties of the new image into the overall 3D graphics model. Thus, for example, if the new image was an image of a transparent magnifying glass, transparent water, or other transparent refracting material, this group would be quite important as the textures of the new image would again contain distorted images of the non-tagged areas of the 3D graphics scene. This group is another good example of high quality “costly signaling” effects, because it also effectively duplicates expensive ray tracing effects which normally would be produced by computationally intensive rendering techniques.

Texture Coordinates—Refraction Layer (N): This layer encodes the texture coordinates (UV) for the new image input areas in reflections. As before, each different new image (input area) will typically have its own layer. To produce this layer, the non-input areas in the 3D graphics model are converted to black, and a special UV material is applied to each of the new image input areas. In some embodiments, the UV material encodes the spatial U data as a Red color, and the spatial V data as a Green color. In some embodiments, this layer can also encode the material type used for the texture as a third “m” coordinate using the blue color. For example, since refraction will often reflect elements from other portions of the 3D graphics image that are not the new image, the m coordinate will often contain the textures for these other non-new image portions of the 3D graphics image. The renderer is requested to only run a raytraced refraction pass. As before, the renderer anti-aliasing is turned off to avoid altering the Red and Green color data.

As an example, the 3D graphics model may contain a magnifying glass object, and the tagged area in the 3D graphics model where the new image will go may be located behind the magnifying glass. This refraction layer makes use of the renderer's ray tracing capability to distort the UV coordinates of the new image textures to make it look as if the new image has been magnified by the magnifying glass. Note that although the resulting distorted image will look to viewers as if the new image was in fact rendered by the renderer, in fact this refraction layer only stores how the renderer will distort the textures of any image put in the location where the new image was put. The net effect is that a final image or video that appears to have been computationally very expensive to produce can in fact be produced with relatively little computational overhead.

Texture Coordinate Derivatives—Input (N) Refraction Layer: This layer is similar to the above layer, with the exception that here the derivatives of the texture coordinates (dU, dV) are run.

Input (N) Mask—Refraction: This is a mask of the coverage of a single new image input area on the output. As before, each different new image (input area) will typically have its own layer. To produce this layer, the single tagged new image input area under consideration in the 3D graphics model is converted to white. All other areas in the 3D graphics model are converted to black. The lighting and shadows are turned off, and the renderer is requested to only run a raytraced refraction pass. The mask layer is semi-optional. As an alternative, which may be used when changes in the lighting color are not needed, the non-light areas of the input light shadow layer below may be set to black or zero, and these non-light areas may be used to convey mask information.

Input Light/Shadow—Refraction (N): This layer encodes the light shadow effects for the new image input areas. Each different new image (input area) will typically have its own layer. To produce this layer, all areas except the particular tagged new image input area are converted to black, and the input area is converted to white. The renderer is invoked, and the refraction render pass results are stored to this layer. This can be a single layer per input (N) with combined lighting, or one layer per input (N), per light (L) for separate lighting effects.

After the Set of New Image Specific Transformations are Done, the Following Transformations are then Done on the Image as a Whole:

Depth: This layer or layers (more than one may be used) encodes the depth (camera z-coordinate) of the front most objects at every pixel in the scene. To produce this layer, the renderer is run with the unchanged 3D graphics model, and the depth pass data from the renderer is taken and stored. For open renderers, a suitable software driver may be written to extract this z-coordinate data. For closed renderers, this data may be extracted by alternate means, such as inserting obscuring layers into the 3D graphics model that only allow pixels from front objects to be observed by the renderer, and then outputting the results. Various types of depth layers and operations are possible. As will be described later, the depth layer can be used as a simple depth mask, or it can be used to impart differential fog or focus to a scene.

Glow: This layer encodes pixels in the scene that have brightness higher than a given threshold. Thus, for example, if the maximum output from an element with pure reflected light would be 100 units, than any light output in excess from the amount expected with pure output light would be the observed output minus the cutoff amount. Thus a lamp or a fire will give off more light than just the amount of light impinging on the object, and will be recorded in this glow pass. This layer adds additional realism. For example, if the new image is within the area illuminated by a lamp in the scene, the additional illumination from the lamp should also illuminate the new image as well.

To produce the glow layer, scene is rendered as normal and the glow pass is stored as this buffer. Alternatively, if the renderer does not support or export a glow rendering pass, this information may be extracted from a standard render pass using a subsequent image processing step.

Typically for video images, each video time frame has its own set of metadata layers. Thus in the example above, if two new image areas were tagged in the 3D graphics model, each video timeframe could be composed of the following metadata image files.

### Layers in One Metafilm Video Frame:

1 Background layer

1 Input specular layer

2 New-image basic texture groups, comprising 2 coordinate layers, 2 derivative layers, 2 input mask layers, and 2 input light shadow layers.

2 New-image reflection texture groups, comprising 2 coordinate layers, 2 derivative layers, 2 input mask layers, and 2 input light shadow layers.

2 New-image refraction texture groups, comprising 2 coordinate layers, 2 derivative layers, 2 input mask layers, and 2 input light shadow layers.

1 Depth layer

1 Glow layer.

This could be a total of 1+1+2(4)+2(4)+2(4)+1+1 or 16 layers of metadata images per video frame (assuming that a video is being produced). The actual number will vary according to use of optional mask layers, individual lighting control, and the need for fewer or greater additional layers to simplify processing, or add additional detail (i.e. various depth levels and effects) to the final image.

Such video files are often referred to in this specification as “metafilm”. Of course fewer layers can be used as production needs dictate, and additionally the information does not need to be contained in separate files, but rather can be merged into larger single files as appropriate. In fact, the metadata for a complete video, or multiple videos, could be stored in a single database file, or other complex data structure, as desired. Such a complex data structure will also be designated as meta film, since the information is still contained in the complex data structure, and the data layout is simply slightly different.

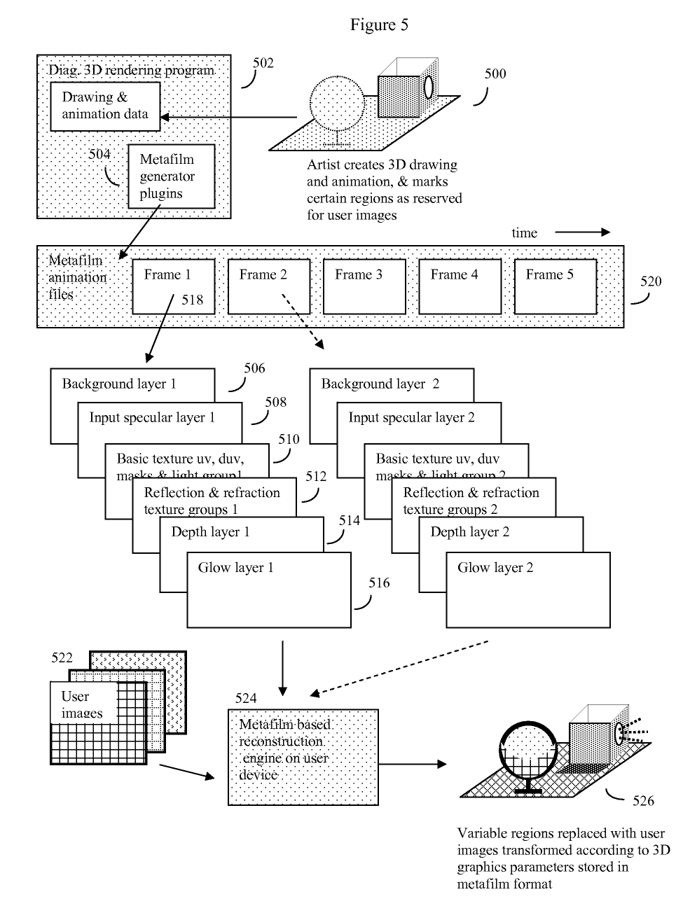

FIG. 5 shows an overview of the entire process. Here the artist creates a 3D graphics computer model (500) (similar to FIG. 1 (100), and marks or tags certain areas of the model as being targets for new images or textures. This model (500) is rendered by diagnostic 3D rendering program (502) and its diagnostic or reporting metafilm generator plugins (504). These are similar to FIG. 2 (200), rendering pass control (208), metafilm generator scripts (210), and the metafilm generator plugins (212). The output from the diagnostic 3D rendering program is a large number of files containing the diagnostic information or reporter information in the form of the various layers discussed above.

Very often, the 3D graphics model will contain animation information, and/or the new image or images will also be in the form of video images. In either case, when this occurs, typically a new 3D graphics scene with one or more new images must be generated at a video frame rate, such as a rate of 15, 24, 30, or 60 frames per second. In this situation, it is convenient to think of each of the layers (506), (508), (510), (512), (514), (516) generated for every frame as being associated together to form a unit similar to a motion picture film frame (518), and the sum of the various video images as being bundled together to form a higher order structure called metafilm (520).

Note that as previously discussed, typically the vast majority of the computing power (computational steps) needed to create the rendered 3D graphics images are expended by the 3D rendering program (502). Most of this computing power normally goes to waste after the initial 3D rendered image is generated. Metafilm allows much of this computing power to be saved in a form that greatly reduces the computational overhead needed to merge new images with the partially rendered 3D graphics images.

FIG. 5 also shows an overview of the process of replacing the tagged areas of the 3D graphics model with new images (522) (similar to FIG. 1 (118)). As a quick first approximation, the new user images (522), and the metafilm (520) are processed by a type of digital compositing software or system called a metafilm rendering engine (524), creating a high quality 3D graphics image (526) which looks as if it has been rendered by a computationally intensive 3D rendering program (502), rather than rendered by a computationally inexpensive metafilm rendering engine (524). Specifically 3D graphics image (526) looks impressive because it looks as computationally intensive steps, such as the ray tracing steps required for refraction, reflection, etc., have been done on new image (522). In fact, they have not (or rather they were done once for a different image, and then saved), but the results look about the same as if they had been rendered for this occasion on a computationally expensive renderer.

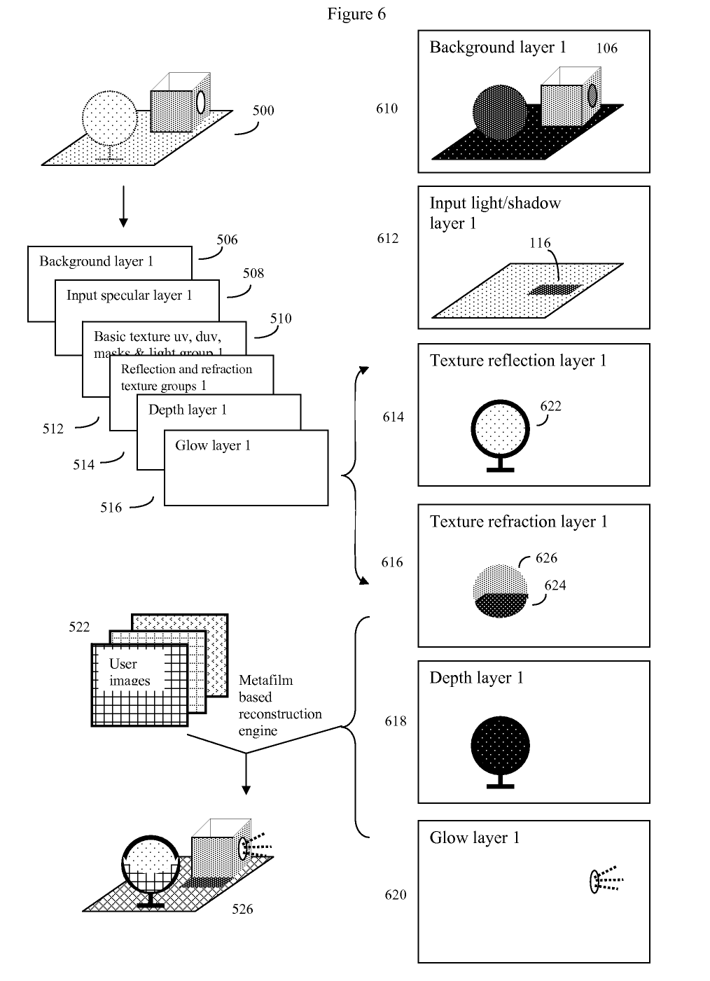

FIG. 6 shows additional details of one example of some of the information that can be encoded into various layers of a metafilm frame. In these example illustrations, occasionally the non-image background, which would normally be colored black, is colored white so that the graphics can be more easily seen.

Here, the 3D computer graphic model (500), and its various layers (506), (508), (510), (512), (514), (516) previously shown in FIG. 5 are again shown. Some of these various layers are shown in more detail as (610), (612), (614), (616), (618), and (620).

Layer (610) is the background layer of the 3D graphics image. The background layer consists of the elements of 3D graphics image (500) that are invariant. That is, these elements don't change regardless of what new image (522) is used.

Layer (612) is the input light and shadow layer for the tagged area corresponding to FIG. 1 (104). This shows that most of the new image (522) is evenly illuminated by diffuse lighting, however part of the new image is shadowed. This corresponds to the shadow (116) cast by FIG. 1 box (106) and light source (110).

Layer (614) shows a detail of the texture reflection layer. This layer encodes the data of how the shiny rim material (112) of the magnifying glass FIG. 1(102) reflects textures from other objects in the 3D graphics model, including user images (522). This is shown as (622). Here each pixel of (622) in this layer maps to the appropriate reflection texture distortion information. In order to accurately show surfaces from other (non-tagged and non-new image) portions of the 3D graphics model reflected in the shiny rim material of the lens, the “m” coordinate for this layer may map to other textures in the 3D graphics image. Here, however, the rim is too small to show this effect clearly.

Layer (616) shows a detail of the texture refraction layer. This layer encodes the data of how the transparent refracting lens material (114) from lens (102) refracts textures from other objects in the 3D graphics model, including user images (522). This is shown as (624) and (626). Again, each pixel of (624) and (626) in this layer maps to the appropriate refraction texture distortion information. In order to accurately show surfaces from other (non-tagged and non-new image) portions of the 3D graphics model refracted by the transparent lens, the “m” coordinate for this layer may map to other textures in the 3D graphics image. Thus the “m” coordinate for the area designated by (626) maps to the texture of the new image (FIG. 1 (118)) because, as shown in FIG. 1, this portion of the magnifying glass is magnifying the tagged area (104) that the artist designated would be replaced by new images. By contrast, the “m” coordinate for the area designated by (624) is magnifying a different texture—in this case a blank texture. In a different model, (626) could instead be the texture of some non-variant object.

Layer (618) shows a detail of the depth layer. In this example, the depth layer is acting as a rather crude depth mask so that the magnifying glass, which is located near the front of the 3D graphics image, obscures the pixels of any object that becomes behind the magnifying glass. In this simplistic example, the transparency and refraction aspects of the magnifying glass are being ignored.

Layer (620) shows a detail of the glow layer. In one simple implementation, the glow layer may simply provide extra illumination to use to enhance the illumination of the completed image after most of the other parts of the image have been reassembled.

Note that this simplified example does not show all of the various metafilm layers. For example, mask layers have been omitted, as well as the derivative layers and the other illumination layers, since the function of these layers should be evident.

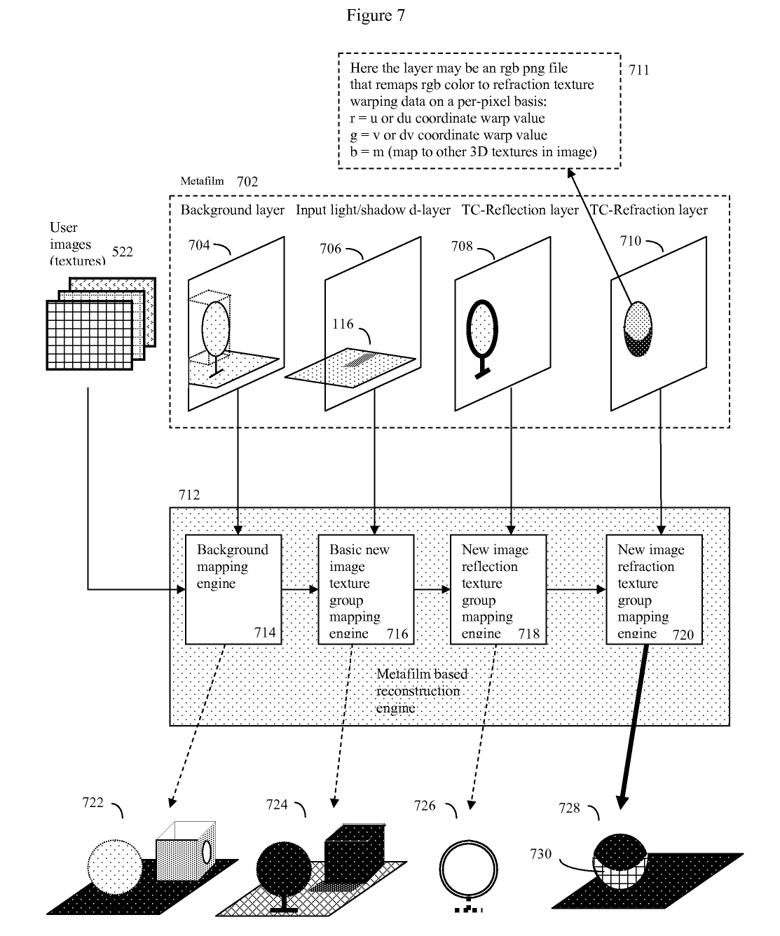

FIG. 7 shows an overview of the process by which a new image may be combined with the data from various metafilm layers in an automated digital compositing process to produce or reconstruct a final image that looks as if the new image was rendered as part of the original 3D graphics scene, but in fact was produced by a process that was much less computationally intensive.

Mathematically, the new images can be imbedded into the data produced from the partially rendered 3D graphic images by various steps. These steps can vary as the number of layers, and the desired degree of complexity of the final image, but are generally intended to be performed automatically (i.e. by computer), with little or no human intervention required. One example, in which the mask layers and mask layer operations, as well as the input specular layer and operations, have been omitted for simplicity, is shown below:

For each pixel (x, y) in the final output image:

Step 1: The corresponding pixel from the background layer is retrieved and stored.

Step 2: The new image basic (diffuse) texture group is computed by:
2.1: The diffuse texture coordinate (u,v), (u,v,m) new image input area data for the tagged area in the 3D graphics image is retrieved from the texture coordinates—diffuse layer, and this coordinate data is used as a location index to fetch texture data from the new image (input texture).
2.2 For this fetched new image pixel, the amount of light used to diffusely illuminate this fetched new image pixel is determined by multiplying the value for this fetched image pixel times the input light/shadow diffuse layer illumination data for this pixel. Thus if the light/shadow diffuse layer level pixel shows that this area was brightly illuminated in the original rendered 3D image, the corresponding new image pixel will also be brightly illuminated. In some embodiments, the diffuse texture group can also be multiplied by the corresponding intensity values from the input specular layer to simulate an additional (and optional) specular effect.

Step 3: The new image reflection texture group is computed by:
3.1: The reflection texture coordinate (u,v), (u,v,m) new image input area data for the tagged area in the 3D graphics image is retrieved from the texture coordinates—reflection layer, and this coordinate data is used as a location index to fetch texture data from either the new image (input texture) or, in the case where another part of the 3D graphics scene is being reflected in the tagged area occupied by the new image, from the “m” coordinate that contains textures from other parts of the 3D graphics image.
3.2 For this fetched new image pixel, the amount of light used to diffusely illuminate this fetched new image pixel is determined by multiplying the value for this fetched image pixel times the input light/shadow reflection layer illumination data for this pixel. Thus if the light/shadow reflection layer level pixel shows that this area was brightly illuminated in the original rendered 3D image, the corresponding new image pixel will also be brightly illuminated.

Step 4: The new image refraction texture group is computed by:
4.1: The refraction texture coordinate (u,v), (u,v,m) new image input area data for the tagged area in the 3D graphics image is retrieved from the texture coordinates—refraction layer, and this coordinate data is used as a location index to fetch texture data from either the new image (input texture) or, in the case where another part of the 3D graphics scene is being refracted into the tagged area occupied by the new image, from the “m” coordinate that contains textures from other parts of the 3D graphics image.
4.2 For this fetched new image pixel, the amount of light used to diffusely illuminate this fetched new image pixel is determined by multiplying the value for this fetched image pixel times the input light/shadow refraction layer illumination data for this pixel. Thus if the light/shadow refraction layer level pixel shows that this area was brightly illuminated in the original rendered 3D image, the corresponding new image pixel will also be brightly illuminated.

Step 5. The results from steps 1, 2, 3, and 4 (i.e. the base image, the new image basic (diffuse) texture group image, the new image reflection texture group image, and the new image refraction texture group image are added together (summed). This works because the non-image portions of all the component images, in this example, are set to be black. Alternatively one or more mask layers can also be used here.

Step 6: For additional realism, the Glow layer data is retrieved, and multiplied times the results of step 5. The results from this multiplication are then added to the results from step 5. Thus if portions of the original 3D graphics image were illuminated more intensely by a glowing light, then portions of the new image will also appear to be illuminated more intensely by the glowing light.

Step 7: For additional realism, the Depth layer may be used to insert additional 3D effects, such as fog or depth of field, or image order. For example, if the user desires to insert a new 3D image into a partially rendered 3D image, the new 3D image may be masked by the depth layer, so that if portions of the partially rendered 3D image that should be in front of the new 3D image would normally block or obscure the new 3D image, then the depth layer will mask portions of the new 3D image. Alternatively the Depth layer may selectively change the color range and brightness of the distant portions of the partially rendered 3D image, or selectively blur the image of the distant portions of the partially rendered 3D image. If necessary, more than one depth layer may be used.

FIG. 7 shows some of these reconstruction steps in diagrammatic form. Again for ease of viewing, some of the non-image portions of the various layers, which might normally be portrayed as black, are here shown in white in order to make the diagrams easier to interpret.

The process begins when a new user image or video (522) is selected for embedding into a tagged portion of a partially rendered 3D graphics model. This is the same 3D graphics model previously discussed in FIGS. 1, 5 and 6, which only has a single tagged area FIG. 1 (104) for only one new image. Thus in this discussion, the “n” for all layers is just 1, so this “n” value will frequently be omitted in order to simplify the discussion and drawings still further. Thus, for example the “Input light/shadow—diffuse (n)” layer will often simply be abbreviated as the “Input light/shadow d-layer”.

Some of the many rendering steps used to create the partially rendered 3D graphics model have been captured on various layers of metafilm (702). Some of these layers in this example include the background layer (704), the input light/shadow diffuse layer (n) for this particular new image (706), the texture coordinates—reflection layer (n) for this new image (708), and the texture coordinates—refraction layer (n) for this new image (710).

It is often convenient to speak of the various software operations used to reconstruct a new image from user images and metafilm as being a reconstruction engine, or a metafilm based reconstruction engine (712). This is because the various software routines and procedures work together, and often will be loaded into computer memory and invoked as a single unit. Note that in contrast to prior art digital compositing systems, the metafilm based reconstruction system has a fixed, highly optimizable path, which automatically applies the same “rendering” operations on the new user images as were originally applied by the diagnostic 3D graphics renderer software.

The metafilm based reconstruction engine consists of various software routines that merge the new images with the various metafilm layers, generally according to the processes outlined in steps 1-7 above. In this simplified example, the metafilm reconstruction engine (712) would load the background layer (704), which contains much of the basic invariant portions of the original rendered 3D graphics image.

The engine (712) would then load the selected user image (522), and process this image through the various steps outlined in the new image basic (diffuse) texture group, and in step 2 above. Here FIG. 7 show (706) shows the input light/shadow diffuse layer (n), which in turn informs engine (712) and (716) that the new image (700) should generally be lit evenly, but the area that will be obscured by the box (see FIG. 1(116) will receive less light.

The appearance of the image as it goes thorough the various processing steps is shown in (722), (724), (726), and (728). The background image (722) contains the box, and invariant portions of the magnifying lens image, but the area where the new graphic image (700) will be mapped is masked out in black. By contrast, image (724) shows the results of the basic new image texture group mapping engine (716), which is performing step 2. As can be seen, the new image (522) (shown as a mesh or grid in the drawing) has been mapped onto the tagged area of the graphics model (see FIG. 1 (104), and additionally the diffuse lighting and shading, such as adding the shadowed region next to the box (see FIG. 1(116) has also been done.

Next (or in parallel), the new image reflection texture group mapping engine (718). The would then load the selected user image (522), and process this image through the various steps outlined in the new image reflection texture group, and in step 3 above. Here FIG. 7 (708) shows the texture coordinates reflection layer input (n), which in turn informs engine (712) and (718) that the new image (522) should be distorted according to the reflective rim of the magnifying glass (see FIG. 1 (112). To make this more realistic and accurate, layer (708) will often incorporate textures from other portions of the original 3D graphics image in its “m” coordinate, and map these textures onto parts of the tagged new image region (see FIG. 1(104). The results of this reflection pass (718) are shown in (726). Here, for ease of viewing, the non reflecting background areas of the scene are shown as white. Often, these areas will in fact be black to facilitate the final additive image reconstruction process previously discussed for step 7.

Next (or in parallel), the new image refraction texture group mapping engine (720). The would then load the selected user image (522), and process this image through the various steps outlined in the new image reflection texture group, and in step 4 above. Here FIG. 7 (710) shows the texture coordinates reflection layer input (n), which in turn informs engine (712) and (720) that the new image (522) should be distorted according to the transparent refractive lens of the magnifying glass (see FIG. 1 (114). To make this more realistic and accurate, layer (710) will often incorporate textures from other portions of the original 3D graphics image in its “m” coordinate, and map these textures, as well as textures from new image (522) onto parts of the tagged new image region (see FIG. 1 (104). Some of the math that may be used for this mapping process is also shown (711). The results of this reflection pass (720) are shown in (728). As can be seen a portion of the texture (square meshwork) from new image (522) is shown magnified and distorted inside the magnifying glass (730).

As previously discussed, the metafilm based reconstruction engine (712) may take these intermediate images, and other images (not shown), and add them together to create a final image, as previously discussed for steps 5, 6, and 7. The resulting image in this example will look like the image previously shown in FIG. 5 (526) and FIG. 6 (526).

The resulting merged images and videos can be output in many different formats, including the wide variety of image and video formats previously discussed, as well as web friendly formats such as Flash, Silverlight, etc.

### Internet Applications:

Although the full process of 3D graphic image creation, rendering into metafilm, and merging of new user images back into metafilm by a metafilm reconstruction engine can be done on a single computer, or series of networked computers, with one or multiple processors, often it will be convenient to divide the tasks over multiple computers, computerized devices, and servers connected by a network, such as the internet. Although the process can be done using a standard processor, and even a processor without a graphics oriented instruction set, in other cases, it may be useful to run at least parts of the metafilm based reconstruction operations through either a graphics processing unit, or a standard computer processor equipped with a graphics processing instruction set. An example of processors suitable for these operations include the common x86 processor family, the ARM processor family, the MIPs processor family, and so on.

Many different types of networked configurations are possible. As one example, the metafilm for various 3D scenes, and the metafilm reconstruction engine could be stored on a first set of networked servers; the various new images could be stored on a second set of networked servers, users using internet connected computers, cell phones, or other computerized devices could either upload images directly to the first set of networked servers, or submit remote requests for the second set of servers to send images to the first set of servers. In this example, the first set of networked servers would then merge the new images with the metafilm, and send the resulting reconstructed images and video back to the original user computers, cell phones, or computerized devices that made the original request.

Often this network will be the internet, and the networked servers will communicate using one or more standard internet data packet protocols, such as TCP/IP, streaming video, or other protocol.

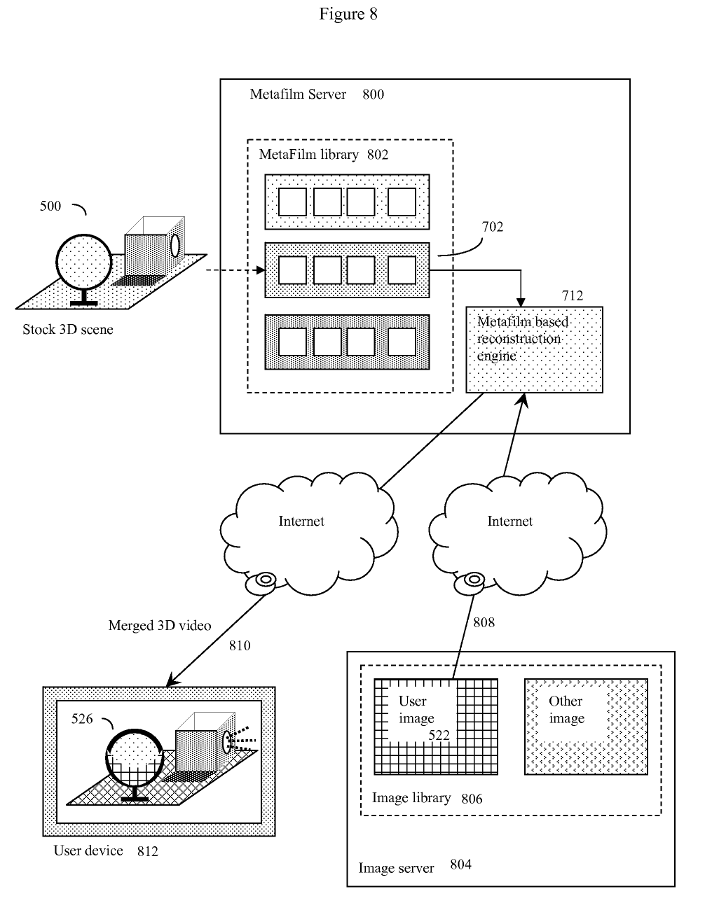

FIG. 8 shows an outline of one such network process. In this example, a variety of different stock 3D graphics images or scenes, such as stock 3D graphics scene (500), previously discussed, are rendered to metafilm (702), using a customized diagnostic 3D rendering program, such as the FIG. 2 program (200), previously discussed. By rendering multiple stock 3D graphics images, a library of different metafilm scenes (802) can be created and stored in the memory of metafilm server (800). In some embodiments, server (800) may just store metafilm, but in this simplified example, metafilm server (800) also has the software code and computational ability to run a metafilm based reconstruction engine (712).

In this example, a second server (804) has a library (806) composed of different types of images and video, which includes the user image (522) previously discussed, as well as other images. This image server can either reside on the user's computer, cell phone, or computerized device, or alternatively be on another computer or server. In any event, in this simplified example, in response to a user stimulus or other prompt, the image server (804) sends user image (522) from the image library (806) over the internet (808) to metafilm server (800). This server then retrieves the requested metafilm (in this example, metafilm (702)), and merges the metafilm (702) with the internet transmitted user image (522) using metafilm based reconstruction (712) (see FIG. 7 for more detail), producing a combined image or video. This combined image or video is then transmitted over the internet (810) to another computer, cell phone, or computerized device (812), which in some configurations can also be the same image server (804) which sent the original user images or video in the first place. The combined video or image (526) is then displayed on user device (812).

Applications for this process include computerized picture frames that dispense high quality 3D graphics images customized with user photos and movies, cell phone video “ring tones” for cellular telephones that can be instantly customized to show user images, such as photos of frequent cell phone callers, arranged in a pleasing 3D graphics background such as a virtual art gallery, rapidly customized internet web pages or advertising, where a companies' products or logos are displayed in a pleasing and realistic 3D world, and compelling 3 dimensional online games, where the 3D online world is rendered using a stock 3D graphics model, but then inexpensively customized using user submitted photos and videos.

### Alternative Embodiments

Alternatively, the invention can be considered to be a method of customizing 3D computer-generated scenes by changing the materials, textures, lighting, and inserting/replacing new objects, followed an ability to re-process them rapidly. Using this invention, stock 3D scenes can be produced by standard commercial 3D graphics tools such as Maya, 3D studio Max, and Blender, and these scenes can then be utilized across different proprietary renderers such that the scene customization can naturally blend with the native renderer. The invention can dynamically incorporate new objects and materials using procedural image manipulation techniques and dynamic shaders. The invention also gives an ability to do dynamic UV mapping for new materials being composited into a scene. Further, the invention allows all of these steps to be done in a manner such that artists can follow a simple guideline while creating scenes that will require customization later.

There are a number of additional advantages to this approach. One is that because the algorithm is adaptable, it can scale uniformly irrespective of user load, content, 3D rendering contexts, and type of final video encoding. An additional advantage is that this approach can use off-the-shelf hardware, and due to its computational efficiency, the video creation costs are extremely low. For example, for creation of customized 15 second video clip, it is possible to have a price per video stream that is less than one hundredth of a penny per clip.

For this specialized and customized blending of 3D and user data, new videos and images can be produced at speeds that are a few orders of magnitude faster than commercially available rendering programs such as Maya and 3D studio max. This enables such videos and images to be quickly mass produced in internet servers, and then distributed with minimal energy costs and overhead.

As previously discussed, the system can be made compatible with commercial renderers such as Maya, 3D studio max, and Blender, and thus can be made compatible with the large industry investment and expertise in this technology. Because this approach is compatible with industry standards, it can be used to enable artists around the globe to create 3D content and upload it to servers. From a novel business method perspective, this can create both new business models and new markets for both corporate and independent 3D artists.

At present, an independent 3D artist may spend months developing a compelling 3D artistic computer model (for example of a compelling imaginary world), yet this artist earn very little financial return because no matter how compelling the 3D model is, the market for art by itself is extremely limited. Using the methods of the present invention, however, artists can develop their 3D art using a variety of different tools, and this art in turn can be rapidly customized and monetized.

As an example, by utilizing the methods of the present invention, the independent 3D artist of our example can now realize additional revenue by licensing use of his or her model as a stock 3D scene for a variety of different advertisers. These advertisers can use the methods of the present invention to rapidly create many customized variants of the original model, thus creating sophisticated “costly signaling” advertisements. This will increase sales to the advertiser's clients, and allow the independent 3D artist to tap into a new revenue stream.

This process of “checking in” images (i.e. uploading the images to a server, such as that shown in FIG. 8), turning the images into metafilm, and licensing use can be further facilitated by use of server software with user friendly interfaces. Such software might, for example, interact with the artist's web browser over the internet, and make it easy for the artist to upload 3D models, as well as manipulate the artist's 3D models (for example, simple editing routines could allow an artist to designate “target” areas of their models that can be replaced by alternate images). This user interface software may also allow the artist some control over the metafilm production process, artistic guidelines, and licensing options.

Advertisers or other consumers of the system may in turn access these stock models through a second set of server/internet browser user friendly interfaces. Such advertiser software might allow advertisers to simply and easily select the stock 3D images of interest, simply and easily select what images or videos the customer wishes to embed into the stock 3D scenes, and even control where the merged images or videos are finally distributed to. The net result will be a large number of compelling customized images, each one of which can be viewed as “costly signaling” because they will look as if the original artist put a great deal of time and effort creating the scene, and they will also look as if they had been then rendered using computationally expensive 3D rendering systems using sophisticated and expensive techniques such as ray tracing.

As previously discussed, in addition to output to various video and image formats, the combined images and video produced by the invention can be output into other formats as well, such as the Adobe Flash™ SWF format, and other rich interactive media formats such as Adobe Flex, Adobe Shockwave, Java FX, Apple QuickTime, and Microsoft Silverlight™. These formats, which are often used as internet browser plugins, and which contain vector and raster graphics, animation, scripting languages, and the like can readily deliver rich content to web browsers anywhere in the world, and thus greatly increase the potential market for a graphic artist's work. In addition to advertising, this work may be used for massively multiplayer online role-playing games (MMORPG), web servers, video servers, cellular telephones, and many other applications as well.

1. A method to embed at least one new graphical image or video file (new graphical images) into partially rendered three-dimensional (3D) computer graphical scenes, said method comprising:
constructing a 3D graphics model of a scene, and designating areas in said model where replacement by new graphical images is desired (designated areas);
rendering said 3D graphics model into graphical scene output files by a series of rendering passes, in which at least one of said rendering passes is a reporting rendering pass that outputs diagnostic information files pertaining to the status of the areas in said 3D graphics model where replacement by new graphical images is desired;
obtaining new graphical images, and merging them with the graphical scene output files by transforming the new graphical images according to said diagnostic information files, and then merging the transformed new graphical images with the graphical scene output files, producing output files containing composite images.

2. The method of claim 1, in which the graphical scene output files are encoded into two-dimensional (2D) computer graphic image files, or computer files composed of a series of 2D graphic images that vary with time (video files).

3. The method of claim 3, in which the 2D computer graphic image files are in formats selected from the group consisting of jpeg, tiff, raw, png, gif, bmp, ppm, pgm, pbm, pnm, svg, postscript, pdf, swf, wmf, lossless file formats, lossy file formats, and vector file formats;
and in which the files of 2D graphic images that vary with time (video files) are in formats selected from the group consisting of 3pg2, 3gp, 3gp2, 3gpp, 3 mm, 60d, aep, ajp, amv, asf, asx, avb, avi, avs, bik, bix, box, byu, camrec, cvc, d2v, dat, dce, dif, dir, divx, dmb, dpg, dv, dvr-ms, dxr, eye, fcp, flc, fli, flv, flx, gl, grasp, gvi, gvp, ifo, imovieproj, imovieproject, ivf, ivs, izz, izzy, lsf, lsx, m1v, m21, m2v, m4e, m4u, m4v, mjp, mkv, mod, moov, mov, movie, mp21, mp4, mpe, mpeg, mpg, mpv2, mqv, msh, mswmm, mvb, mvc, nsv, nvc, ogm, pds, piv, playlist, pro, prprog, prx, qt, qtch, qtz, rm, rmvp, rp, rts (realplayer), rts (quicktime realtime streaming format), sbk, scm, sfvidcap, smil, smv, spl, srt, ssm, str, svi, swf, swi, tda3mt, tivo, ts, vdo, veg, vf, vfw, vid, viewlet, viv, vivo, vob, vp6, vp7, vro, w32, wcp, wm, wmd, wmv, wmx, wvx, and yuv, lossy video files, lossless video files, and vector video files.

4. The method of claim 1, in which the diagnostic information files are encoded into two-dimensional (2D) computer graphic image files, or computer files composed of a series of 2D graphic images that vary with time (video files).

5. The method of claim 4, in which the 2D) computer graphic image files are in formats selected from the group consisting of jpeg, tiff, raw, png, gif, bmp, ppm, pgm, pbm, pnm, svg, postscript, pdf, swf, wmf, lossless file formats, lossy file formats, and vector file formats;
and in which the files of 2D graphic images that vary with time (video files) are in formats selected from the group consisting of 3pg2, 3gp, 3gp2, 3gpp, 3 mm, 60d, aep, ajp, amv, asf, asx, avb, avi, avs, bik, bix, box, byu, camrec, cvc, d2v, dat, dce, dif, dir, divx, dmb, dpg, dv, dvr-ms, dxr, eye, fcp, flc, fli, flv, flx, gl, grasp, gvi, gvp, ifo, imovieproj, imovieproject, ivf, ivs, izz, izzy, lsf, lsx, m1v, m21, m2v, m4e, m4u, m4v, mjp, mkv, mod, moov, mov, movie, mp21, mp4, mpe, mpeg, mpg, mpv2, mqv, msh, mswmm, mvb, mvc, nsv, nvc, ogm, pds, piv, playlist, pro, prprog, prx, qt, qtch, qtz, rm, rmvp, rp, rts (realplayer), rts (quicktime realtime streaming format), sbk, scm, sfvidcap, smil, smv, spl, srt, ssm, str, svi, swf, swi, tda3mt, tivo, ts, vdo, veg, vf, vfw, vid, viewlet, viv, vivo, vob, vp6, vp7, vro, w32, wcp, wm, wmd, wmv, wmx, wvx, and yuv, lossy video files, lossless video files, and vector video files.

6. The method of claim 1, in which the new graphical images were stored in two-dimensional (2D) computer graphic image files, or computer files composed of a series of 2D graphic images that vary with time (video files).

7. The method of claim 6, in which the 2D computer graphic image files are in formats selected from the group consisting of jpeg, tiff, raw, png, gif, bmp, ppm, pgm, pbm, pnm, svg, postscript, pdf, swf, wmf, lossless file formats, lossy file formats, and vector file formats;
and in which the files of 2D graphic images that vary with time (video files) are in formats selected from the group consisting of 3pg2, 3gp, 3gp2, 3gpp, 3 mm, 60d, aep, ajp, amv, asf, asx, avb, avi, avs, bik, bix, box, byu, camrec, cvc, d2v, dat, dce, dif, dir, divx, dmb, dpg, dv, dvr-ms, dxr, eye, fcp, flc, fli, flv, flx, gl, grasp, gvi, gvp, ifo, imovieproj, imovieproject, ivf, ivs, izz, izzy, lsf, lsx, m1v, m21, m2v, m4e, m4u, m4v, mjp, mkv, mod, moov, mov, movie, mp21, mp4, mpe, mpeg, mpg, mpv2, mqv, msh, mswmm, mvb, mvc, nsv, nvc, ogm, pds, piv, playlist, pro, prprog, prx, qt, qtch, qtz, rm, rmvp, rp, rts (realplayer), rts (quicktime realtime streaming format), sbk, scm, sfvidcap, smil, smv, spl, srt, ssm, str, svi, swf, swi, tda3mt, tivo, ts, vdo, veg, vf, vfw, vid, viewlet, viv, vivo, vob, vp6, vp7, vro, w32, wcp, wm, wmd, wmv, wmx, wvx, and yuv, lossy video files, lossless video files, and vector video files.

8. The method of claim 1, in which said rendering passes output diagnostic information files pertaining to the status of the areas in said 3D graphics model where replacement by new graphical images is desired (designated areas) by the steps of:
In at least one reporting rendering pass, altering the rendering parameters to new settings that report on the status of the designated areas, and creating diagnostic information files that contain the status information produced as a result of this reporting rendering pass.

9. The method of claim 8, in which the designated areas in the 3D graphics model are associated with a reporter material, and the reporter material interacts with the reporting rendering pass to output diagnostic information files pertaining to the lighting, UV texture, refraction, reflection, and ray tracing properties of the designated areas within the overall context of the rendered 3D graphics scene.

10. The method of claim 8, in which the reporter material reflects 100% of the light impinging on the reporter material by specular reflection, reflects 100% of the light impinging on the reporter material by diffuse reflection, or contains a series of markings that enables the reflection or refraction of the reporter material by other elements of the 3D graphics model to be accurately tracked during a reporter rendering pass.

11. The method of claim 8, in which the reporting rendering method uses reporter lighting or shading that interacts with the reporter material during the reporting rendering pass, and outputs diagnostic information files pertaining to the UV texture, refraction, and reflection properties of the designated areas within the overall context of the rendered 3 dimensional graphical scene.

12. The method of claim 11, in which the various sources of reporter lighting are orthogonal to each other, or in which the various sources of reporter lighting are composed of different pure colors.

13. The method of claim 1, in which said new graphical images are merged with the graphical scene output files by a transformation process that first alters the new graphical images by a process that rotates or UV distorts, or enlarges or shrinks, or warps or recolors, or crops said new graphical images based upon data encoded in the diagnostic information files; and
then replaces regions in the graphical scene output files that correspond to the designated areas in the rendered 3D model with the altered new graphical images.

14. The method of claim 13, in which at least some of the transformation processes are done by running the transformation process on a graphics processing unit.

15. The method of claim 1, in which the 3D graphics model of a scene contains animation data showing how the model changes with time, and in which the graphical scene output files change with time in response to said animation data, and in which the new graphical images are either still images or a series of images that vary with time.

16. The method of claim 1, in which the graphical scene output files and diagnostic information files are stored on a first internet server, the new graphical images are stored on a second internet server, and the new graphical images are sent to the first server, merged with the graphical scene output files and diagnostic files, and the composite images are then sent back to either the second server or a third server.

17. A method to embed at least one new graphical image or video file (new graphical images) into partially rendered three-dimensional (3D) computer graphical scenes, said method comprising:
constructing a 3D graphics model of a scene, and designating areas in said model where replacement by new graphical images is desired (designated areas);
rendering said three dimensional graphics model into two-dimensional (2D) graphical scene output files in a series of rendering passes;
in which the 2D graphical scene output files are encoded into 2D computer graphic image files, or computer files composed of a series of 2D graphic images that vary with time (video files);
in which at least one of said rendering passes is a reporting rendering pass that automatically outputs diagnostic information files pertaining to the status of the areas in said 3D graphics model where replacement by new graphical images is desired;
in which the diagnostic information files are encoded into 2D computer graphic image files, or computer files composed of a series of 2D graphic images that vary with time (video files);
obtaining new graphical images, and automatically merging them with the graphical scene output files by transforming the new graphical images according to said diagnostic information files, and then merging the transformed new graphical images with the graphical scene output files, producing output files containing composite images;
in which the new graphical images were stored in two-dimensional (2D) computer graphic image files, or computer files composed of a series of 2D graphic images that vary with time (video files).

18. The method of claim 17, in which the 2D computer graphic image files are in formats selected from the group consisting of jpeg, tiff, raw, png, gif, bmp, ppm, pgm, pbm, pnm, svg, postscript, pdf, swf, wmf, lossless file formats, lossy file formats, and vector file formats;
and in which the files of 2D graphic images that vary with time (video files) are in formats selected from the group consisting of 3pg2, 3gp, 3gp2, 3gpp, 3 mm, 60d, aep, ajp, amv, asf, asx, avb, avi, avs, bik, bix, box, byu, camrec, cvc, d2v, dat, dce, dif, dir, divx, dmb, dpg, dv, dvr-ms, dxr, eye, fcp, flc, fli, flv, flx, gl, grasp, gvi, gvp, ifo, imovieproj, imovieproject, ivf, ivs, izz, izzy, lsf, lsx, m1v, m21, m2v, m4e, m4u, m4v, mjp, mkv, mod, moov, mov, movie, mp21, mp4, mpe, mpeg, mpg, mpv2, mqv, msh, mswmm, mvb, mvc, nsv, nvc, ogm, pds, piv, playlist, pro, prprog, prx, qt, qtch, qtz, rm, rmvp, rp, rts (realplayer), rts (quicktime realtime streaming format), sbk, scm, sfvidcap, smil, smv, spl, srt, ssm, str, svi, swf, swi, tda3mt, tivo, ts, vdo, veg, vf, vfw, vid, viewlet, viv, vivo, vob, vp6, vp7, vro, w32, wcp, wm, wmd, wmv, wmx, wvx, and yuv, lossy video files, lossless video files, and vector video files.

19. The method of claim 17, in which said rendering passes output diagnostic information pertaining to the status of the areas in said 3D graphics model where replacement by new graphical images is desired (designated areas) by the steps of:
in at least one reporting rendering pass, altering the rendering parameters to new settings that report on the status of the designated areas, and creating diagnostic information files that contain the status information produced as a result of this reporting rendering pass.

20. The method of claim 19, in which the designated areas in the 3D graphics model are associated with a reporter material, and the reporter material interacts with the reporting rendering pass to output diagnostic information files pertaining to the lighting, UV texture, refraction, reflection, and ray tracing properties of the designated areas within the overall context of the rendered 3D graphics scene.

21. The method of claim 20, in which the reporter material reflects 100% of the light impinging on the reporter material by specular reflection, reflects 100% of the light impinging on the reporter material by diffuse reflection, reflects a pure color, or contains a series of markings that enables the reflection or refraction of the reporter material by other elements of the three dimensional model to be accurately tracked during a reporter rendering pass; or in which the rendering method uses reporter lighting or shading that interacts with the reporter material during the reporting rendering pass, and outputs diagnostic information files pertaining to the UV texture, refraction, reflection, and ray tracing properties of the designated areas within the overall context of the rendered 3-dimensional graphical scene.

22. The method of claim 21, in which the various sources of reporter lighting are orthogonal to each other, or in which the various sources of reporter lighting are composed of different pure colors.

23. The method of claim 17, in which said new graphical images are merged with the graphical scene output files by a transformation process that first alters the new graphical images by a process that rotates or UV distorts, or enlarges or shrinks, or warps or recolors, or crops said new graphical images based upon data encoded in the diagnostic information files; and
then replaces regions in the graphical scene output files that correspond to the designated areas in the rendered 3D model with the altered new graphical images.

24. The method of claim 23, in which at least some of the transformation processes are done by running the transformation process on a graphics processing unit.

25. The method of claim 23, in which the information needed to implement the transformation process is obtained from the image information portion of diagnostic information files encoded into 2D computer graphic image file formats.

26. The method of claim 17, in which the 3D graphics model of a scene contains animation data showing how the 3D graphics model changes with time, and in which the graphical scene output files change with time in response to said animation data, and in which the new graphical images are either still images or a series of images that vary with time.

27. The method of claim 17, in which the graphical scene output files and diagnostic information files are stored on a first internet server, the new graphical images are stored on a second internet server, and the new graphical images are sent to the first server, merged with the graphical scene output files and diagnostic files, and the composite images are then sent back to either the second server or a third server.

28. A method to embed at least one new graphical image or video file (new graphical images) into partially rendered 3 dimensional (3D) computer graphical scenes, said method comprising:
constructing a 3D graphics model of a scene, and designating areas in said model where replacement by new graphical images is desired (designated areas);
rendering said three dimensional graphics model into two dimensional (2D) graphical scene output files in a series of rendering passes;
in which the 2D graphical scene output files are encoded into 2D computer graphic image files, or computer files composed of a series of 2D graphic images that vary with time (video files);
in which at least one of said rendering passes is a reporting rendering pass that automatically outputs diagnostic information files pertaining to the status of the areas in said 3D graphics model where replacement by new graphical images is desired;
in which the designated areas in the 3D graphics model are associated with a reporter material, and the reporter material interacts with the reporting rendering pass to create diagnostic information pertaining to the lighting, UV texture, refraction, reflection, and ray tracing properties of the designated areas within the overall context of the rendered 3D graphics scene;
or in which the reporting rendering method uses reporter lighting or shading that interacts with the reporter material during the reporting rendering pass, and creates diagnostic information pertaining to the UV texture, refraction, reflection, and ray tracing properties of the designated areas within the overall context of the rendered 3D graphics scene;
in which the diagnostic information files are encoded into 2D computer graphic image files, or computer files composed of a series of 2D graphic images that vary with time (video files);
obtaining new graphical images, and automatically merging them with the graphical scene output files by transforming the new graphical images according to said diagnostic information, and then merging the transformed new graphical images with the graphical scene output files, producing output files containing composite images;
in which the new graphical images were stored in two-dimensional (2D) computer graphic image files, or computer files composed of a series of 2D graphic images that vary with time (video files).

29. The method of claim 28, in which the 2D computer graphic image files are in formats selected from the group consisting of jpeg, tiff, raw, png, gif, bmp, ppm, pgm, pbm, pnm, svg, postscript, pdf, swf, wmf, lossless file formats, lossy file formats, and vector file formats;
and in which the files of 2D graphic images that vary with time (video files) are in formats selected from the group consisting of 3pg2, 3gp, 3gp2, 3gpp, 3 mm, 60d, aep, ajp, amv, asf, asx, avb, avi, avs, bik, bix, box, byu, camrec, cvc, d2v, dat, dce, dif, dir, divx, dmb, dpg, dv, dvr-ms, dxr, eye, fcp, flc, fli, flv, flx, gl, grasp, gvi, gvp, ifo, imovieproj, imovieproject, ivf, ivs, izz, izzy, lsf, lsx, m1v, m21, m2v, m4e, m4u, m4v, mjp, mkv, mod, moov, mov, movie, mp21, mp4, mpe, mpeg, mpg, mpv2, mqv, msh, mswmm, mvb, mvc, nsv, nvc, ogm, pds, piv, playlist, pro, prprog, prx, qt, qtch, qtz, rm, rmvp, rp, rts (realplayer), rts (quicktime realtime streaming format), sbk, scm, sfvidcap, smil, smv, spl, srt, ssm, str, svi, swf, swi, tda3mt, tivo, ts, vdo, veg, vf, vfw, vid, viewlet, viv, vivo, vob, vp6, vp7, vro, w32, wcp, wm, wmd, wmv, wmx, wvx, and yuv, lossy video files, lossless video files, and vector video files.

30. The method of claim 28, in which the reporter material reflects 100% of the light impinging on the reporter material by specular reflection, reflects 100% of the light impinging on the reporter material by diffuse reflection, reflects a pure color, or contains a series of markings that enables the reflection or refraction of the reporter material by other elements of the three dimensional model to be accurately tracked during a reporter rendering pass.

31. The method of claim 28, in which the various sources of reporter lighting are orthogonal to each other, or in which the various sources of reporter lighting are composed of different pure colors.

32. The method of claim 28, in which said new graphical images are merged with the graphical scene output files by a transformation process that first alters the new graphical images by a process that rotates or UV distorts, or enlarges or shrinks, or warps or recolors, or crops said new graphical images based upon data encoded in the diagnostic information files; and
then replaces the graphical scene output files that correspond to the designated areas in the rendered 3D model with the altered new graphical images.

33. The method of claim 32, in which at least some of the transformation processes are done by running the transformation process on a graphics processing unit.

34. The method of claim 32, in which the information needed to implement the transformation process is obtained from the image information portion of diagnostic information files encoded into 2D computer graphic image file formats.

35. The method of claim 28, in which the 3D graphics model of a scene contains animation data showing how the 3D graphics model changes with time, and in which the graphical scene output files change with time in response to said animation data, and in which the new graphical images are either still images or a series of images that vary with time.

36. The method of claim 28, in which the graphical scene output files and diagnostic information files are stored on a first internet server, the new graphical images are stored on a second internet server, and the new graphical images are sent to the first server, merged with the graphical scene output files and diagnostic files, and the composite images are then sent back to either the second server or a third server.

37. A method of automatically controlling a digital image compositing process, said method comprising:
constructing a 3D graphics model of a scene, and designating areas (designated areas) in said model where replacement by at least one new graphical image or video file (new graphical images) is desired;
rendering said 3D graphics model into graphical scene output files by a series of rendering passes, in which at least one of said rendering passes is a reporting rendering pass that outputs diagnostic information files pertaining to the status of the areas in said 3D graphics model where replacement by new graphical images is desired;
and using said diagnostic information files to automatically control the operation of a digital image compositing process.

38. The method of claim 37, in which said digital compositing process automatically transforms said new graphical images by a transformation process that first alters the new graphical images by a process that rotates or UV distorts, or enlarges or shrinks, or warps or recolors, or crops said new graphical images based upon data encoded in the diagnostic information files; and
then said digital compositing process replaces regions in the graphical scene output files that correspond to the designated areas in the rendered 3D model with the transformed altered new graphical images.

40. The method of claim 38, in which said diagnostic information files report diagnostic information pertaining to information selected from the group consisting of the lighting, UV texture, refraction, reflection, and ray tracing properties of the designated areas within the overall context of the rendered 3D graphics scene.

41. The method of claim 37, in which the 3D graphics model of a scene contains animation data showing how the model changes with time, and in which the graphical scene output files change with time in response to said animation data, and in which the new graphical images are either still images or a series of images that vary with time.

42. A computer image or video file produced by the steps of:
constructing a 3D graphics model of a scene, and designating areas in said model where replacement by new graphical images is desired (designated areas);
rendering said 3D graphics model into graphical scene output files by a series of rendering passes, in which at least one of said rendering passes is a reporting rendering pass that outputs diagnostic information files pertaining to the status of the areas in said 3D graphics model where replacement by new graphical images is desired;
obtaining at least one new graphical image or video file (new graphical images), and merging them with the graphical scene output files by transforming the new graphical images according to said diagnostic information files, and then merging the transformed new graphical images with the graphical scene output files, producing output computer image or video files containing composite images.

43. The computer image or video file of claim 42, in which said rendering passes output diagnostic information files pertaining to the status of the areas in said 3D graphics model where replacement by new graphical images is desired (designated areas) by the steps of:
In at least one reporting rendering pass, altering the rendering parameters to new settings that report on the status of the designated areas, and creating diagnostic information files that contain the status information produced as a result of this reporting rendering pass.

44. The computer image or video file of claim 42, in which the designated areas in the 3D graphics model are associated with a reporter material, and the reporter material interacts with the reporting rendering pass to output diagnostic information files pertaining to the lighting, UV texture, refraction, reflection, and ray tracing properties of the designated areas within the overall context of the rendered 3D graphics scene.

45. The computer image or video file of claim 44, in which the reporter material reflects 100% of the light impinging on the reporter material by specular reflection, reflects 100% of the light impinging on the reporter material by diffuse reflection, or contains a series of markings that enables the reflection or refraction of the reporter material by other elements of the 3D graphics model to be accurately tracked during a reporter rendering pass.

46. The computer image or video file of claim 44, in which the reporting rendering method uses reporter lighting or shading that interacts with the reporter material during the reporting rendering pass, and outputs diagnostic information files pertaining to the UV texture, refraction, reflection, and ray tracing properties of the designated areas within the overall context of the rendered 3 dimensional graphical scene.

47. The computer image or video file of claim 44, in which the various sources of reporter lighting are orthogonal to each other, or in which the various sources of reporter lighting are composed of different pure colors.

48. The computer image or video file of claim 42, in which said new graphical images are merged with the graphical scene output files by an automatic transformation process that first alters the new graphical images by a process that rotates or UV distorts, or enlarges or shrinks, or warps or recolors, or crops said new graphical images based upon data encoded in the diagnostic information files; and
then automatically replaces regions in the graphical scene output files that correspond to the designated areas in the rendered 3D model with the altered new graphical images.

49. The computer image or video file of claim 42, in which the 3D graphics model of a scene contains animation data showing how the model changes with time, and in which the graphical scene output files change with time in response to said animation data, and in which the new graphical images are either still images or a series of images that vary with time.

50. The computer image or video file of claim 42, in which the graphical scene output files and diagnostic information files were stored on a first internet server, the new graphical images were stored on a second internet server, and the new graphical images were sent to the first server, merged with the graphical scene output files and diagnostic files, and the composite images were then sent back to either the second server or a third server.
